(19) United States
(12) Patent Application Publication
(10) Pub. No.: US 2022/0227938 A1
(43) Pub. Date: Jul. 21, 2022

(54) SILYL TERMINATED PREPOLYMER AND COMPOSITION COMPRISING THE SAME

(71) Applicants: SOPREMA, STRASBOURG (FR); UNIVERSITE DE HAUTE ALSACE, Mulhouse Cédex (FR)

(72) Inventors: Baptiste CLEMENT, BERMERING (FR); Pascal PICHON, STRASBOURG (FR); Jean-François STUMBE, STRASBOURG (FR); Baljinder KAUR, KALAMAZOO, MI (US); Jon BALLEMA, KALAMAZOO, MI (US); Rémi PERRIN, BOERSCH (FR); Pierre Etienne BINDSCHEDLER, STRASBOURG (FR)

(21) Appl. No.: 17/609,698

(22) PCT Filed: May 20, 2020
(86) PCT No.: PCT/EP2020/064162

§ 371 Date: Nov. 8, 2021

(30) Foreign Application Priority Data
May 24, 2019 (EP) 19305663.7

(51) Int. Cl. C08G 73/06; C08K 13/02; C09D 179/04; C09J 179/04

(52) U.S. Cl. CPC C08G 73/0633; C08K 13/02; C08K 5/12; C09J 179/04; C09D 179/04

(57) ABSTRACT

The invention relates to a silyl terminated prepolymer and to a curable composition containing this prepolymer. These compositions are used to make sealants, coatings or adhesives useful in the field of construction, public works and civil engineering.

### TECHNICAL FIELD

The invention relates to a silyl terminated prepolymer and to a curable composition containing said prepolymer. These compositions are used to manufacture sealants, coatings or adhesives useful in the field of construction, public works and civil engineering.

### BACKGROUND OF THE INVENTION

In public works or construction works, it is necessary to protect structures, generally made of concrete, against any infiltration of water. To do this, sealants or coatings are applied on the structures.

The use of liquid compositions is preferred over prefabricated membranes as they are easier to apply and lead to flexible and continuous membranes that adhere to the structure.

Sealants or coatings can be obtained from acrylic dispersions in aqueous solution which harden on loss of water. However, these products have the drawback of hardening at the surface after application, forming a very thin coating which makes the evaporation of water difficult, thus giving rise to the formation of blisters. These products cure slowly, especially in cold weather, they are very sensitive to rain before they have totally cured, and they form blisters in summer. What is more, these products show poor resistance to prolonged immersion in water, and are therefore unsuitable for waterproofing horizontal flat surfaces. Finally, their mechanical strength is insufficient for use on traffic-bearing surfaces.

Sealants or coatings obtained with polyurethane resins are also known, for example two-component compositions or one-component compositions containing significant amounts of solvents and/or plasticizers.

Two-component compositions are less practical to apply than one-component compositions as they require special mixing equipment and careful metering of the two components.

Further, the use of solvents generates compositions having the following drawbacks:
an unpleasant odor due to the volatile organic compounds,
a toxicity that results in specific labeling and specific operating conditions,
problems with regard to environmental regulations.

Additionally, the use of inert exogenous plasticizers generates compositions having the following drawbacks:
weakening of the mechanical strength,
weakening of the adhesion,
reduced aging over time,
increased water absorption.

Also, polyurethane resins contain residual diisocyanates which are considered as harmful to health and to the environment since they may release free diisocyanate monomers.

Two-part silicone sealants or coatings can be produced by an addition cure method involving a platinum catalyst. One method can include, for example, a silicone hydride and a vinyl-functionalized resin, which react in the presence of a platinum catalyst by hydrosilylation to form an ethyl group bridge between the two components with no additional byproducts. Such platinum catalyzed hydrosilylation systems, while potentially fast curing, can be easily inhibited by tin, sulfur, or other functionalities present in the system (e.g., amines, etc.).

Further, silyl-modified polymers, such as silyl-modified polyethers (MS polymers) and silyl-modified polyurethanes (SPUR polymers) are commonly utilized in adhesives and sealants. In particular, such compositions have been used in one-component sealants that are moisture cured. Like the two-part sealants described above, hydrosilylation is often employed to form the silyl-modified polymers used in the moisture-curable sealants.

There is still a need for prepolymers and liquid one-component curable compositions to provide elastomeric sealants, coatings or adhesives that exhibit one or more of the following properties:
0-1% by weight of free isocyanate monomers
0-5% by weight of solvent
fast curing at room temperature (20-25° C.)
complying with the requirements of a liquid waterproofing system in terms of elasticity, hydrophobicity, hydrolysis resistance, mechanical properties (tensile strength and elongation) and durability.

### SUMMARY OF THE INVENTION

A first object of the present invention is a prepolymer represented by formula (1):

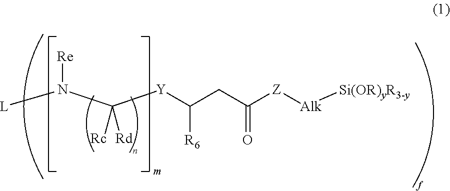

wherein L, Y, Z, R₆, R_{c}, R_{d}, Rₑ, Alk, R, f, m, n and y are as defined herein.

The invention also aims at providing a method for preparing a prepolymer, wherein said method comprises reacting an electrophile of formula (3) with a polyamine or polythiol of formula (4):

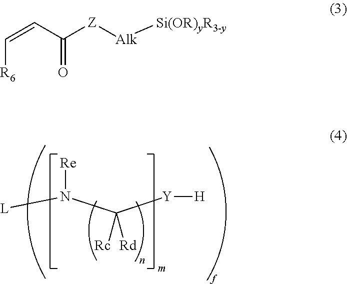

wherein L, Y, Z, R, R_{c}, R_{d}, Rₑ, R₆, Alk, f, n, m and y are as defined herein,
when Y is S or NR′ and R′ is not H, the molar ratio between the hydrogens on the amine or thiol reactive groups of the polyamine or polythiol and the α,β-unsaturated carbonyl groups of the electrophile is from 0.8 to 1.2, preferably 0.9 to 1.1, more preferably 0.95 to 1.05;
when Y is NH, the molar ratio between the hydrogens on the amine reactive groups of the polyamine and the α,β-unsaturated carbonyl groups of the electrophile is from 1.8 to 2.2, preferably 1.9 to 2.1, more preferably 1.95 to 2.05.

Another object of the present invention is a composition comprising a prepolymer according to the invention and mixtures thereof; and an additive selected from a plasticizer, a filler, an adhesion promoter, a pigment or dye, a UV-absorber, a UV-stabilizer, an antioxidant, a moisture scavenger, a fungicide, a biocide, a fire-retardant, a rheology modifier, an oxygen barrier and mixtures thereof.

Yet another object of the present invention is a sealant, coating or adhesive obtained by curing the composition according to the invention, preferably at a temperature of −10 to 50° C., in particular −5 to 45° C., more particularly 0 to 40° C., during a time of 1 to 72 h, in particular 2 to 30 h, more particularly 3 to 24 h.

A final object of the present invention is the use of the composition according to the invention for waterproofing exterior or interior traffic-bearing horizontal surfaces, for making flashings, or for renovating roofs.

### Definitions

The term “plurivalent radical” means any group having one or more, for example two (divalent), three (trivalent), four (tetravalent), five (pentavalent) or six (hexavalent), single bonds as points of attachment to other groups.

The term “hydrocarbyl radical” means a radical containing 1 to 500 carbon atoms. The hydrocarbyl radical may be linear or branched, cyclic or acyclic, saturated or unsaturated, aliphatic or aromatic. The hydrocarbyl radical may be interrupted by one or more functional groups selected from ether (—O—), thioether (—S—), disulfide (—S—S—), ester (—C(O)—O—), amide (—C(O)—NH—), carbamate (—NH—C(O)—O—), urea (—NH—C(O)—NH—), dimethylsiloxane (—Si(Me)₂-O—) and mixtures thereof. One or more of the carbon atoms of the hydrocarbyl radical may be replaced by a nitrogen atom or an isocyanurate group having the following formula:

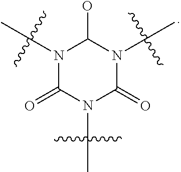 [SMILES: *N1C(=O)N(*)C(O)N(*)C1=O]

The hydrocarbyl radical may be unsubstituted or substituted by one or more substituents as defined below.

The term “alkyl” means a hydrocarbyl containing 1 to 20 carbon atoms. The alkyl groups may be linear or branched, acyclic or cyclic. Examples include methyl, ethyl, n-propyl, isopropyl, cyclopropyl, n-butyl, isobutyl, sec-butyl, tert-butyl, n-pentyl, cyclopentyl, 2-methylbutyl, 2,2-dimethylpropyl, n-hexyl, cyclohexyl, 2-methylpentyl, 2,2-dimethylbutyl, n-heptyl, 2-methylhexyl, and the like. The term “C1-C20 alkyl” means an alkyl containing 1 to 20 carbon atoms.

When the suffix “ene” or “diyl” is used in conjunction with an alkyl or alkenyl group, this means that the group contains two single bonds as points of attachment to other groups (divalent radical).

The term “aryl” means a polyunsaturated aromatic hydrocarbyl containing one ring (i.e. phenyl), several fused rings (for example naphthyl) or several rings linked via a covalent bond (for example biphenyl), which typically contain 6 to 20, and preferentially 6 to 12, carbon atoms, and wherein at least one ring is aromatic. The aromatic ring may optionally comprise one to two additional fused rings (i.e. cycloalkyl, heterocycloalkyl or heteroaryl). The term “aryl” also encompasses partially hydrogenated derivatives of the carbocyclic system is described above. Examples include phenyl, naphtyl, biphenyl, phenanthrenyl, naphthacenyl, and the like. The term “C6-C12 aryl” means an aryl containing 6 to 12 carbon atoms.

The term “alkylaryl” means a linear or branched alkyl substituent containing a carbon atom attached to an aryl ring. Examples include benzyl, naphthylmethyl, phenethyl, and the like. The term “C6-C12 alkylaryl” means an alkylaryl containing 6 to 12 carbon atoms.

The term “X forms a cycle with Y” means that X and Y, together with the atoms to which they are attached, form an optionally substituted cycle. Example of cycles are a succinimide, a piperidine, or a piperazine, respectively represented by the following formulae

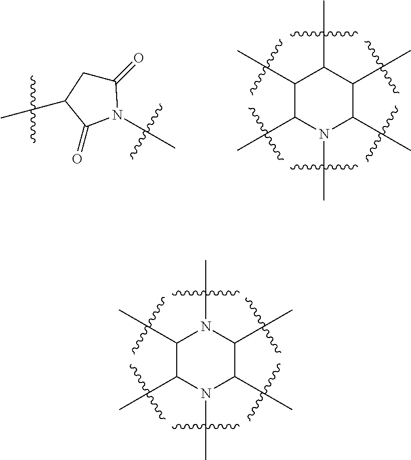 [SMILES: *C1CC(=O)N(*)C1=O ; *C1C(*)C(*)N(*)C(*)C1* ; *C1C(*)N(*)C(*)C(*)N1*]

The following groups: hydrocarbyl radical, alkyl, aryl, alkylaryl and cycle may be unsubstituted or substituted with one or more standard substituents selected from: halogen, alkyl, aryl, hydroxy (—OH), alkoxy (—OR₁₈), haloalkyl, cyano (—CN), carboxyl (—COOH), oxo (═O), formyl (—CHO), ester (—COOR₁₈), imido (═NR₁₈), amido (—CONHR₁₈), a tertiary amino group (—N(R₁₈)₂), nitro (—NO₂), sulfonyl (—SO₂—R₁₈) and mixtures thereof, wherein each R₁₈ is independently C1-C20 alkyl, C6-12 aryl or C6-C12 alkylaryl group.

The term “halogen” refers to chlorine, bromine, fluorine and iodine.

The term “haloalkyl” means an alkyl substituted by a halogen atom. Examples include fluoro-, chloro-, bromo-, or iodo-methyl, -ethyl, -propyl, -isopropyl, -butyl, -isobutyl, -tert-butyl, and the like.

The term “haloaryl” means an aryl substituted by a halogen atom.

The term “haloalkylaryl” means an alkylaryl substituted by a halogen atom.

The term “alkoxy” means a —OR group, where R represents an alkyl, cycloalkyl, aryl or alkylaryl group. Examples include methoxy, ethoxy, propoxy, butoxy, cyclohexyloxy, phenoxy, benzyloxy, and the like.

The term “hydrocarbyl radical derived from an alkane” means a hydrocarbyl radical obtained by removing one or more terminal hydrogens from an alkane. Said radical may further be functionalized as defined above.

The term “hydrocarbyl radical derived from a polyether” means a hydrocarbyl radical interrupted by one or more ether functional groups (—O—). Said radical may further be functionalized as defined above.

The term “hydrocarbyl radical derived from a polyester” means a hydrocarbyl radical interrupted by one or more ester functional groups (—C(O)O—). Said radical may further be functionalized as defined above.

The term “hydrocarbyl radical derived from a polydimethyl siloxane” means a hydrocarbyl radical interrupted by one or more dimethylsiloxane functional groups (—Si(Me)₂-O—). Said radical may further be functionalized as defined above.

The term “hydrocarbyl radical derived from poly(alkyl (meth)acrylate)” means a hydrocarbyl radical substituted by one or more ester functional groups (—COO(C1-C20 alkyl)). Said radical may further be functionalized as defined above.

The term “hydrocarbyl radical derived from a polybutadiene” means a hydrocarbyl radical comprising one or more butenediyl monomeric units. Said radical may further be functionalized as defined above.

The term “hydrocarbyl radical derived from a polysulfide” means a hydrocarbyl radical interrupted by one or more thioether functional groups (—S—). Said radical may further be functionalized as defined above.

The term “hydrocarbyl radical derived from a polyurethane” means a hydrocarbyl radical interrupted by one or more urethane functional groups (—NH—C(O)—O—). Said radical may further be functionalized as defined above.

The term “hydrocarbyl radical derived from an epoxy acrylate” means a hydrocarbyl radical comprising a moiety obtained by reacting an multifunctional epoxy resin and an acrylic acid. Said radical may further be functionalized as defined above.

The term “multifunctional epoxy resin” means a compound or polymer comprising at least two epoxy groups.

The term “multifunctional isocyanate resin” means a compound or polymer comprising at least two isocyanate groups.

The term “multifunctional (meth)acrylate resin” means a compound or polymer comprising at least two (meth)acrylate groups.

The term “multifunctional acrylamide resin” means a compound or polymer comprising at least two acrylamide groups.

The term “multifunctional maleimide resin” means a compound or polymer comprising at least two maleimide groups.

The term “poly(meth)acrylate resin” means a polymer comprising monomeric units derived from acrylic acid, a mono-acrylate, methacrylic acid, a mono-methacrylate, cyanoacrylic acid, a mono-cyanoacrylate, acrylonitrile and mixtures thereof. Said polymer may be an acrylic co-polymer which further comprises monomeric units derived from compounds other than those cited above, such as, for example, acrylamide, a N-substituted acrylamide, a styrene, or vinylacetate.

The term “polyacrylamide resin” means a polymer comprising monomeric units derived from acrylamide, a N-substituted acrylamide and mixtures thereof. Said polymer may be an acrylamide co-polymer which further comprises monomeric units derived from compounds other than those cited above, such as, for example, acrylic acid, a mono-acrylate, methacrylic acid, a mono-methacrylate, cyanoacrylic acid, a mono-cyanoacrylate, acrylonitrile and mixtures thereof.

The term “polymaleimide resin” means a polymer comprising monomeric units derived from maleic anhydride, a N-substituted acrylamide and mixtures thereof.

The term “liquid composition” means that the composition flows under its own weight. In particular, a liquid composition may exhibit a viscosity between 1,000 and 40,000 centipoises, said viscosity being measured at 23° C. using a Brookfield viscometer (for viscosities of less than 10,000 centipoises, the measurements are taken with the R5 module at a speed of 30 rpm and for viscosities of greater than 10,000 centipoises, the measurements are taken with the R6 module at a speed of 20 rpm). Such a viscosity allows the application of the composition especially with a roller commonly known as a fabric roller or a brush to form 0.5 to 2 mm thick layers in one or more applications.

The term “one-component composition” means a ready-to-use composition. In particular, the composition may be applied on its own by the final user, i.e. by the worker who will apply the waterproof coating. Such a ready-to-use composition is conventionally known in the art as a “one-component” composition, as opposed to a “two-component composition” which requires the addition of a catalyst, hardener or another reactive agent before use or which must be applied in a limited time span (a few hours) after being mixed.

The term “curable composition” means a composition comprising a polymer having functional groups capable of forming covalent bonds with chain extenders, cross-linkers or other polymer molecules to form a cross-linked polymer network.

The term “moisture curable composition” means a composition that is cured under the action of air moisture or —OH containing groups.

The term “stable composition” means a composition that can be stored for a minimum of 4 months without any phase separation or mass gelling being observed.

The term “non-toxic composition” means a composition that contains less than 1% by weight of free diisocyanate monomers, according to directive 67/548/EEC (30th ATP directive 2008/58/EC), the free diisocyanate monomer content being measured by gas chromatography coupled to a mass spectrometer (according to standard EN ISO 17734-1/2006).

The term “solvent” means any solvent that is conventionally used in curable compositions, said solvent being inert toward the reagents contained in the composition, liquid at room temperature and having a boiling point below 240° C.

### DETAILED DESCRIPTION OF THE INVENTION

### Prepolymer

The prepolymer of the invention is represented by formula (1):

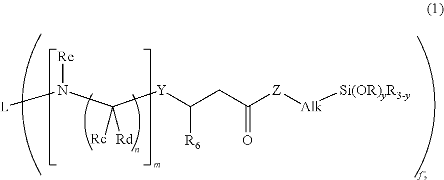

wherein
L is a plurivalent radical;
Y is NR′ or S, preferably Y is NR′;
Z is O or NR₅, preferably Z is O;
R₅ is hydrogen;
R₆ is hydrogen;
or R₅ forms a cycle with R₆, preferably a succinimide;
each R_{c} is independently H, a C1-C20 alkyl, a C6-C12 aryl or a C6-C12 alkylaryl, preferably H, methyl, ethyl, phenyl or benzyl, more preferably H or methyl;
each R_{d} is independently H, a C1-C20 alkyl, a C6-C12 aryl or a C6-C12 alkylaryl, preferably H, methyl, ethyl, phenyl or benzyl, more preferably H or methyl;
or one R_{d} forms a cycle with R′, another R_{d} forms a cycle with Rₑ and the remaining R_{d} are H, a C1-C20 alkyl, a C6-C12 aryl or a C6-C12 alkylaryl, preferably one R_{d} forms a piperidine with R′, another R_{d} forms a piperidine with Rₑ and the remaining R_{d} are H, a C1-C20 alkyl, a C6-C12 aryl or a C6-C12 alkylaryl, more preferably one R_{d} forms a piperidine with R′, another R_{d} forms a piperidine with Rₑ and the remaining R_{d} are H or methyl;
Rₑ is H, a C1-C20 alkyl, a C6-C12 aryl or a C6-C12 alkylaryl, preferably Rₑ is H, methyl, ethyl, butyl, cyclohexyl or phenyl;
R′ is H, a C1-C20 alkyl optionally interrupted by one or more ester functional groups, a C6-C12 aryl or a C6-C12 alkylaryl, preferably R′ is H, methyl, ethyl, isopropyl, isobutyl, 1,2,2-trimethylpropyl, diethyl succinate, benzyl or phenyl;
or R′ and Rₑ form a cycle, preferably a piperazine optionally substituted by one or more groups selected from C1-C20 alkyl, C6-C12 aryl and C6-C12 alkylaryl;
or R′ forms a cycle with one R_{d} and Rₑ forms a cycle with another R_{d}, preferably R′ forms a piperidine with one R_{d} and Rₑ forms a piperidine with another R_{d};
Alk is a linear or branched C1-C20 alkylene, preferably Alk is methylene, propylene or —(CH₂)—(CHCH₃)—(CH₂)—;
each R is independently C1-C20 alkyl, preferably R is methyl or ethyl, more preferably R is methyl;
f is 2 to 6, preferably 2 to 4, more preferably 2 to 3;
m is 0 or 1; and
n is 2, 3, 4, 5, 6, 7, 8 or 9, preferably n is 2; and
y is 0, 1, 2 or 3, preferably y is 2 or 3.

In particular, groups Z and R₆ may be selected to form a moiety selected from propanoate, propanamide, and succinimide.

As such, the prepolymers of the present invention may be represented by one of the following formulae (1a)-(1c):

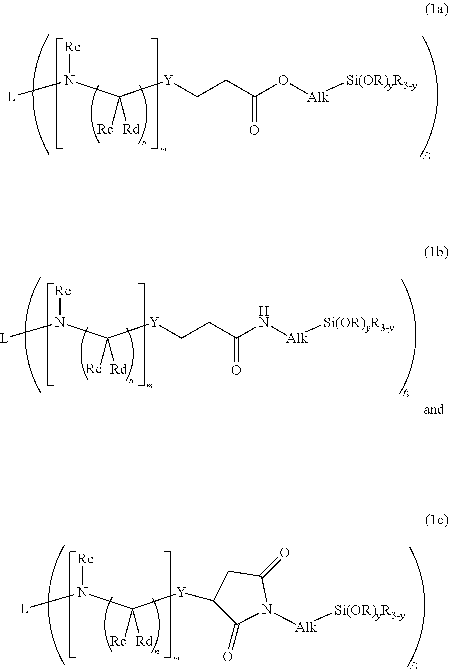

wherein L, Y, R, R_{c}, R_{d}, Rₑ, Alk, f, m, n and y are as defined above.

In a preferred embodiment, the prepolymer of the invention is represented by formula (1a). Group L can be any group. In particular, L may be a plurivalent hydrocarbyl radical containing 1 to 500 carbon atoms. Said plurivalent hydrocarbyl radical may be linear or branched, cyclic or acyclic, saturated or unsaturated, aliphatic or aromatic. Said plurivalent hydrocarbyl radical may be interrupted by one or more functional groups selected from ether, thioether, disulfide, ester, amide, carbamate, urea, dimethylsiloxane and mixtures thereof. One or more of the carbon atoms of said plurivalent hydrocarbyl radical may be replaced by a nitrogen atom or an isocyanurate group. Said plurivalent hydrocarbyl radical may be substituted by one or more substituents selected from halogen, alkyl, aryl, hydroxy, alkoxy, haloalkyl, cyano, carboxyl, oxo, formyl, ester, imido, amido, a tertiary amino group, nitro, sulfonyl and mixtures thereof.

In particular, L may be a plurivalent hydrocarbyl radical derived from

an alkane;
a polyether, preferably a polypropylene glycol, a copolymer of ethylene glycol and propylene glycol or a polytetramethylene glycol;
a polyester, preferably a polyester based on a fatty acid dimer;
a polyurethane;
an isocyanurate;
an epoxy acrylate, preferably a bio-based acrylated epoxidized resin;
a polydimethyl siloxane;
a poly(alkyl (meth)acrylate);
a polybutadiene;
a polysulfide;
and combinations thereof.

Preferably L is a plurivalent hydrocarbyl radical derived from an alkane, a polyurethane, a polyether, a polybutadiene and combinations thereof. More preferably, L is a plurivalent hydrocarbyl radical comprising 3 to 250 carbon atoms derived from an alkane, a polyurethane, a polyether, a polybutadiene and combinations thereof.

In a first embodiment of the invention Y is NR′, m is 0 and L, R, R′, R₆, Z, Alk, f and y are as defined above.

In said first embodiment, R′ may be H, a C1-C20 alkyl optionally interrupted by one or more ester functional groups, a C6-C12 aryl or a C6-C12 alkylaryl, preferably R′ is H, methyl, ethyl, isopropyl, isobutyl, 1,2,2-trimethylpropyl, diethyl succinate, benzyl or phenyl.

In said first embodiment, L may be a linear or branched, cyclic or acyclic, saturated or unsaturated, aliphatic or aromatic, divalent or trivalent, hydrocarbyl radical comprising 1-500 carbon atoms, said radical being optionally interrupted by one more functional groups selected from ether, ester, amide, dimethylsiloxane, and mixtures thereof, said radical optionally having one or more carbon atoms replaced with a nitrogen atom or an isocyanurate group, said radical being optionally substituted by one or more substituents selected from halogen, hydroxy, alkoxy, an ester group and mixtures thereof.

In said first embodiment, L is preferably a plurivalent hydrocarbyl radical derived from a polyether, a polybutadiene and combinations thereof. More preferably, L is a plurivalent hydrocarbyl radical comprising 3 to 250 carbon atoms, in particular 50 to 220 carbon atoms derived from a polyether, a polybutadiene and combinations thereof.

In said first embodiment, L may preferably be represented by one of formulae (La)-(Lm):

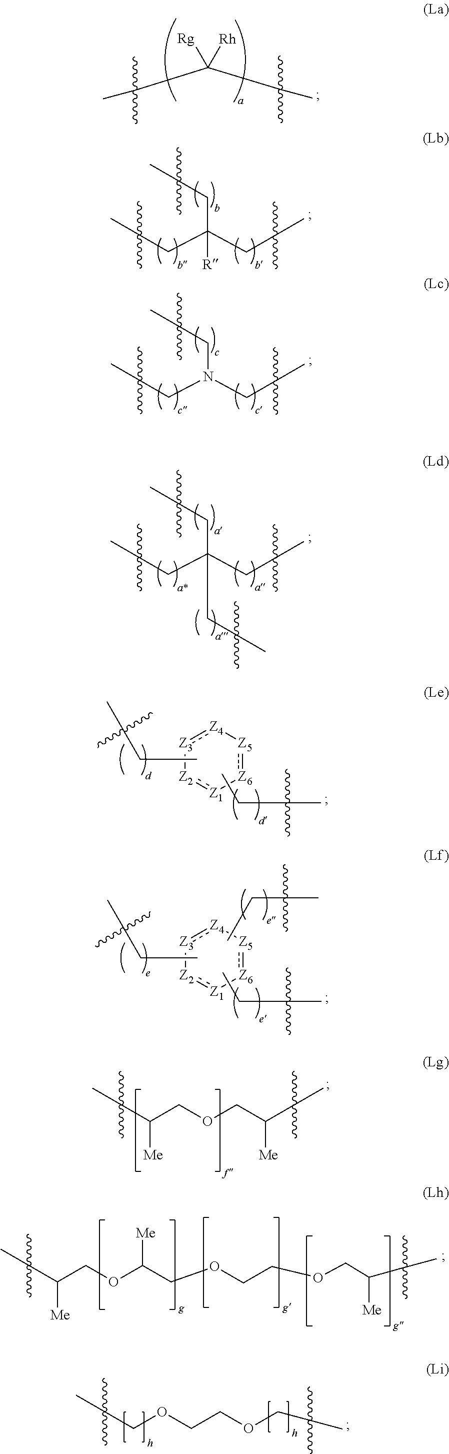

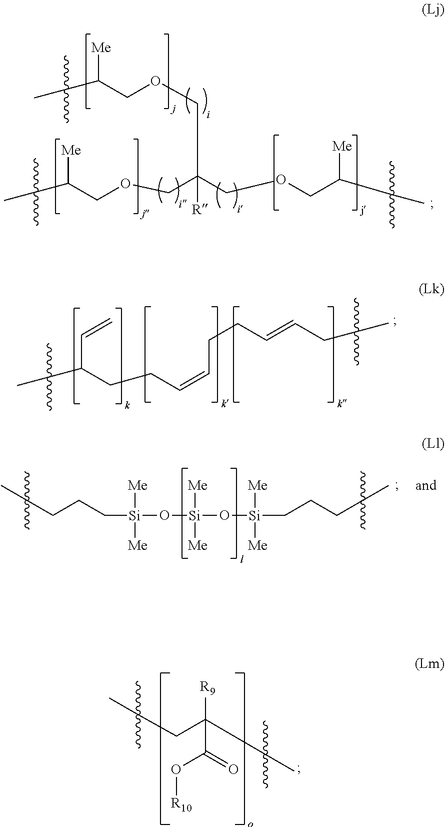

wherein
Z₁, Z₂, Z₃, Z₄, Z₅ and Z₆ are independently CRₓR_{y} or NR_{z};
R″ is H or C1-C20 alkyl optionally substituted by OH or alkoxy;
R₉ is H or methyl;
R₁₀ is C1-C20 alkyl;
R_{g} and Rₕ are independently H or C1-C20 alkyl;
Rₓ, R_{y} and R_{z} are independently absent, H or C1-C20 alkyl;
the dashed lines represent a single or double bond;
a is 2 to 12;
a′, a″, a′″, a*, b, b′, b″, c, c′ and c″ are independently 0 to 6;
d, d′, e, e′ and e″ are independently 0 to 3;
f″ is 2 to 100;
g′ is 2 to 50 and g+g″ is 1 to 10;
h is 2 to 10;
i, i′ and i″ are independently 0 to 3;
j+j′+j″ is 5 to 100;
k, k′ and k″ are independently 0 to 50;
l is 5 to 150; and
o is 1 to 100.

Preferably, the L group of the first embodiment is selected from one of formulae (Lg)-(Lk).

In a second embodiment of the invention, Y is NR′, m is 1 and L, R, R′, R_{c}, R_{d}, Rₑ, R₆, Z, Alk, f, n and y are as defined above.

The prepolymer of said second embodiment may be represented by formula (1d):

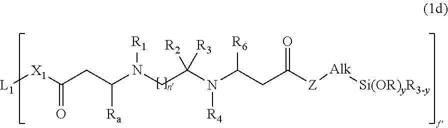

wherein
Z, Alk, R, R₆ and y are as defined above;
X₁ is O or NR_{b}, preferably X₁ is O;
L₁ is a plurivalent radical;
Rₐ is hydrogen;
R_{b} is hydrogen;
or Rₐ forms a cycle with R_{b}, preferably a succinimide;
R₁ and Rₐ are independently C1-C20 alkyl, C6-C12 aryl or C6-C12 alkylaryl, preferably methyl, ethyl, phenyl or benzyl, more preferably methyl;
or R₁ and R₄ form a cycle, preferably a piperazine, more preferably a piperazine optionally substituted with one or more groups selected from C1-C20 alkyl, C6-C12 aryl, C6-C12 alkylaryl, halogen, C1-C20 haloalkyl, C6-C12 haloaryl and C6-C12 haloalkylaryl, even more preferably a piperazine optionally substituted with one or more groups selected from methyl, ethyl, chloro, phenyl, chlorophenyl and benzyl, more preferably still substituted with methy;
R₂ and R₃ are independently selected from H, C1-C20 alkyl, C6-C12 aryl, C6-C12 alkylaryl, halogen, C1-C20 haloalkyl, C6-C12 haloaryl or C6-C12 haloalkylary, preferably H, methyl, ethyl, chloro, phenyl, chlorophenyl or benzyl, more preferably H or methyl, with the proviso that at least one of R₂ and R₃ is not H;
2≤f′≤6, preferably 2≤f′≤4, more preferably 2≤f′≤3;
n′ is 1, 2, 3, 4, 5 or 6, preferably n′ is 1.

Alternatively, the prepolymer of said second embodiment may be represented by formula (1e):

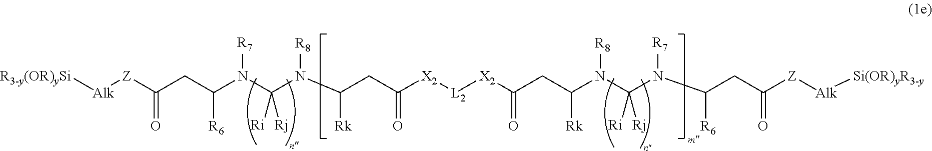

wherein
Z, Alk, R, R₆, and y are as defined above;
X₂ is O or NRᵢ, preferably X₂ is O;
each L2 is independently a plurivalent radical;
Rᵢ is hydrogen;
Rⱼ is hydrogen;
or one Rⱼ forms a cycle with R₇, another Rⱼ forms a cycle with R₈ and the remaining Rⱼ are hydrogen, preferably one Rⱼ forms a piperidine with R₇, another Rⱼ forms a piperidine with R₈ and the remaining Rⱼ are hydrogen;
Rₖ is hydrogen;
Rₗ is hydrogen;
or Rₖ forms a cycle with Rₗ, preferably a succinimide;
R₇ and R₈ are independently selected from C1-C20 alkyl, C6-C12 aryl or C6-C12 alkylaryl, preferably methyl, ethyl, phenyl or benzyl, more preferably methyl;
or R₇ et R₈ form a cycle, preferably a piperazine, more preferably a non-substituted piperazine; or R₇ forms a cycle with one Rⱼ and R₈ forms a cycle with another Rⱼ, preferably R₇ forms a piperidine with one Rⱼ and R₈ forms a piperidine with another Rⱼ;
n″ is 2, 3, 4, 5, 6, 7, 8 or 9;
1<m″≤10, preferably 1,5≤m″≤8, more preferably 2≤m″≤6.

In said second embodiment, each L₁ and L₂ may independently be a linear or branched, cyclic or acyclic, saturated or unsaturated, aliphatic or aromatic, divalent, trivalent, tetravalent, pentavalent or hexavalent, hydrocarbyl radical comprising 1-500 carbon atoms, said radical being optionally interrupted by one more functional groups selected from ether, ester, amide, carbamate, urea and mixtures thereof, said radical optionally having one or more carbon atoms replaced by an isocyanurate group, said radical being optionally substituted by one or more substituents selected from halogen, hydroxy, alkoxy and mixtures thereof.

Preferably, in said second embodiment, L₁ is a plurivalent hydrocarbyl radical derived from an alkane, a polyether, a polyurethane and combinations thereof. More preferably, L₁ is a plurivalent hydrocarbyl radical comprising 3 to 200 carbon atoms derived from an alkane, a polyether, a polyurethane and combinations thereof. Even more preferably, L₁ is a plurivalent hydrocarbyl radical comprising 100-150 carbon atoms derived from a polyether, a plurivalent hydrocarbyl radical comprising 3-20 carbon atoms derived from an alkane or a plurivalent hydrocarbyl radical comprising 100-150 carbon atoms derived from a polyurethane.

Preferably, in said second embodiment, each L₂ is independently a plurivalent hydrocarbyl radical derived from an alkane, a polyether, a polyurethane and combinations thereof. Even more preferably, each L₂ is independently a plurivalent hydrocarbyl radical comprising 3 to 20, in particular 4 to 16 carbon atoms, derived from an alkane, a polyether, a polyurethane and combinations thereof. Preferably, in said second embodiment, each L₁ and L₂ may independently be represented by one of the following formulae (L′a)-(L′g2):

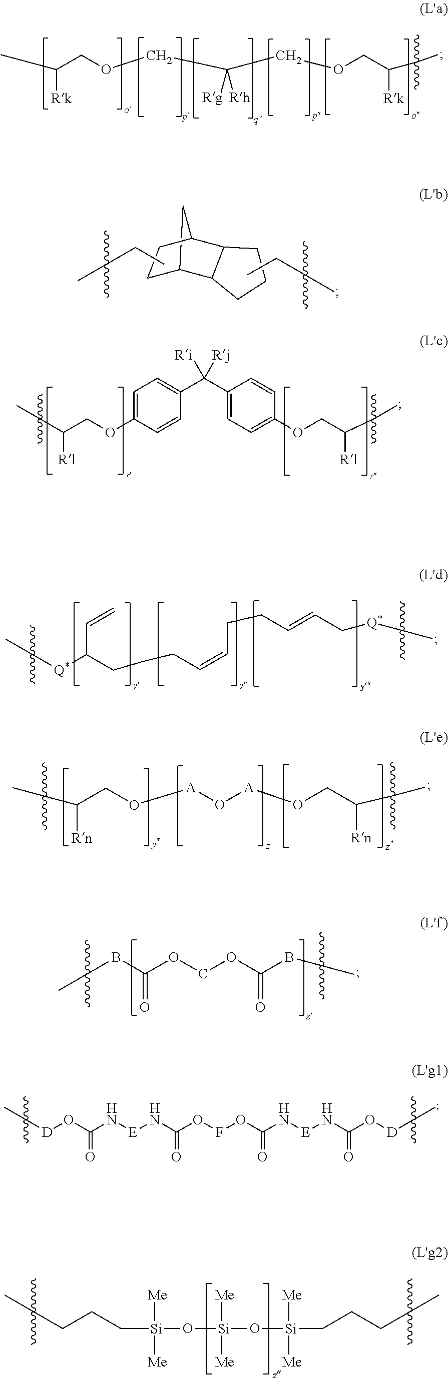

wherein
R′_{g} and R′ₕ are independently H or C1-C20 alkyl, preferably H, methyl or ethyl, more preferably H or methyl;
R′ᵢ and R′ⱼ are independently H, halogen, C1-C20 alkyl, C1-C20 haloalkyl, C6-C12 aryl or C6-C12 alkylaryl; preferably C1-C20 alkyl, more preferably methyl;
each R′ₖ, R′ᵢ and R′ₙ is independently H or methyl;
each A is independently a linear or branched, cyclic or acyclic, saturated or unsaturated alkylene comprising 2 to 20 carbon atoms;
each B is independently a linear or branched, cyclic or acyclic, saturated or unsaturated alkylene comprising 2 to 20 carbon atoms;
C is a linear or branched, cyclic or acyclic, saturated or unsaturated alkylene comprising 4 to 100 carbon atoms optionally interrupted by one or more ether and/or ester functional groups;
each D is independently a linear or branched, cyclic or acyclic, saturated or unsaturated alkylene comprising 2 to 20 carbon atoms;
each E is independently a linear or branched, cyclic or acyclic, saturated or unsaturated alkylene comprising 4 to 100 carbon atoms optionally interrupted by one or more ether and/or carbamate functional groups;
each F is independently a linear or branched, cyclic or acyclic, saturated or unsaturated alkylene comprising 4 to 100 carbon atoms optionally interrupted by one or more ether and/or carbamate functional groups;
each Q* is independently a linear or branched alkylene comprising 0 to 100 carbon atoms optionally interrupted by one or more ether and/or ester functional groups;
o′, o″, r′, r″, y′, y″, y*, z and z* are independently 0 to 50;
p′, p″ and q′ are independently 0 to 10;
z′ is 1 to 10;
z″ is 5 to 150.

Alternatively, in said second embodiment L₁ may be represented by one of the following formulae (L′h)-(L′m) and each L₂ may independently be represented by one of the following formulae (L″h)-(L″m):

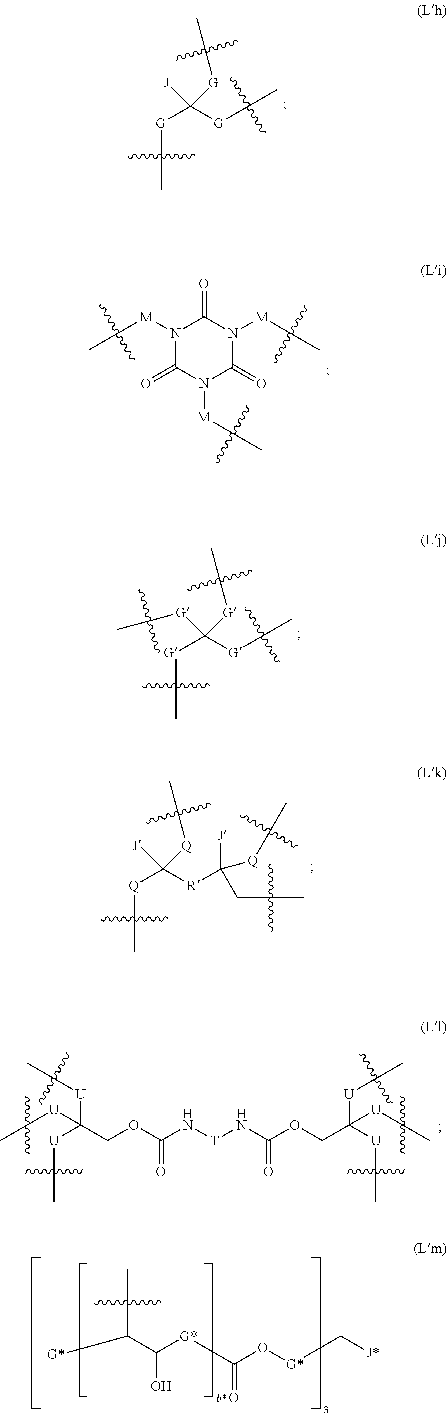

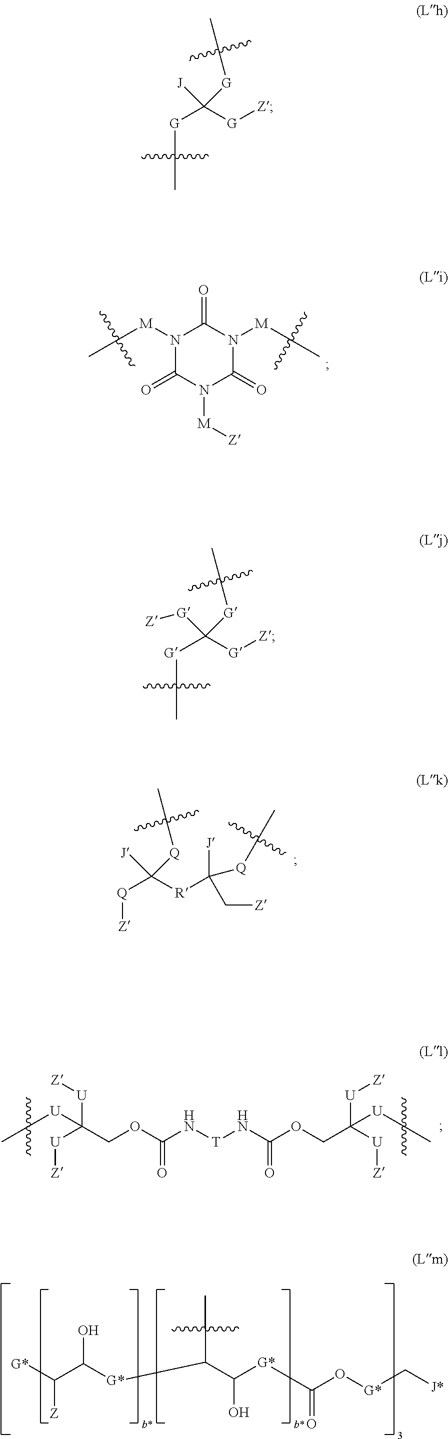

wherein
each G is independently a linear or branched alkylene comprising 0 to 100 carbon atoms optionally interrupted by one or more ether and/or ester functional groups;
each G′ is independently a linear or branched alkylene comprising 0 to 100 carbon atoms optionally interrupted by one or more ether and/or ester functional groups;
each G* is independently a linear or branched alkylene comprising 0 to 100 carbon atoms J, J′ and J* are independently H or a linear or branched alkyl comprising 1 to 20 carbon atoms, optionally substituted by hydroxy or alkoxy;
each M is independently a linear or branched, cyclic or acyclic alkylene comprising 1 to 20 carbon atoms optionally interrupted by one or more ether and/or carbamate functional groups;
each Q is independently a linear or branched alkylene comprising 0 to 100 carbon atoms optionally interrupted by one or more ether functional groups;
R* is a linear or branched alkylene comprising 1 to 20 carbon atoms optionally interrupted by one or more ether functional groups;
T is a linear or branched, cyclic or acyclic, saturated or unsaturated alkylene comprising 4 to 100 carbon atoms optionally interrupted by one or more ether and/or carbamate functional groups;
each U is independently a linear or branched alkylene comprising 0 to 100 carbon atoms optionally interrupted by one or more ether and/or ester functional groups;
each Z′ is independently represented by the following formula:

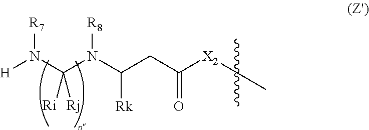

wherein X₂, R₇, R₈, Rᵢ, Rⱼ, Rₖ and n″ are as defined above for formula (1e);
each b* is independently 1, 2 or 3 with the proviso that that formula (L′m) does not comprise more than six b* units;
each c* is independently 0 or 1 with the proviso that formula (L″m) comprises two c* units;
each d* is independently 0, 1, 2 or 3 with the proviso that that formula (L″m) does not comprise more than four d* units.

In a third embodiment of the invention, Y is S, m is 0 and L, R, R₆, Z, Alk, f and y are as defined above.

In said third embodiment, L may be a linear or branched, cyclic or acyclic, saturated or unsaturated, aliphatic or aromatic, divalent, trivalent or tetravalent, hydrocarbyl radical comprising 2 to 300 carbon atoms, said radical being optionally interrupted by one or more functional groups selected from ether, ester, thioether, disulfide and mixtures thereof, said radical being optionally substituted by one or more substituents selected from halogen, hydroxy, alkoxy and mixtures thereof.

Preferably, the L group of the third embodiment may be represented by one of formulae (Ln)-(Lv):

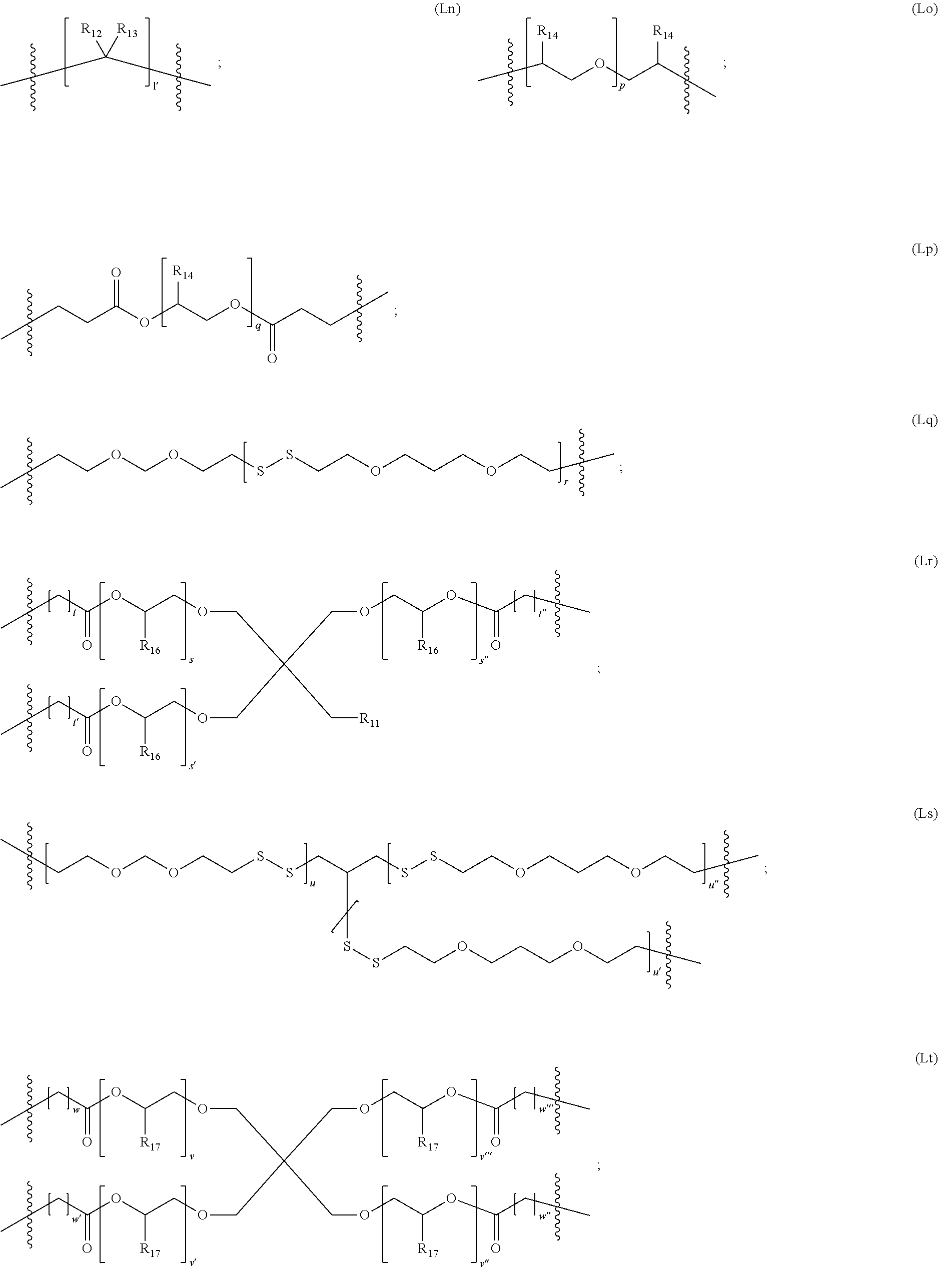

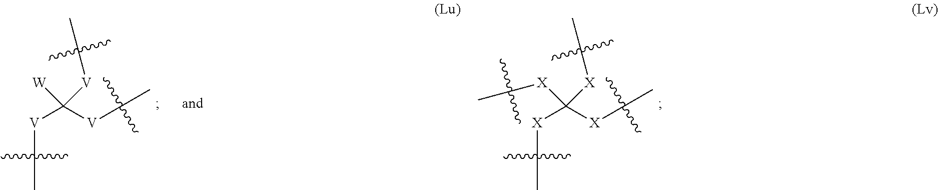

wherein
R₁₁ is H or C1-C20 alkyl optionally substituted by hydroxy or alkoxy;
R₁₂ and R₁₃ are independently H or C1-C20 alkyl;
each R₁₄, R₁₅, R₁₆ and R₁₇ is independently H or methyl;
each V is independently a linear or branched alkylene comprising 0 to 100 carbon atoms optionally interrupted by one or more ether functional groups;
W is H or C1-C20 alkyl optionally substituted by hydroxy or alkoxy;
each X is independently a linear or branched alkylene comprising 0 to 100 carbon atoms optionally interrupted by one or more ether functional groups;
p, q, r, u, u′ and u″ are independently 1 to 50;
s, s′, s″, v, v′, v″ and v′″ are independently 0 to 50; and
t, t′, t″, w, w′, w″ and w″ are independently 1 or 2.

In all of the preceding embodiments, the R group of the prepolymer may, in particular, be methyl or ethyl and y may be 2 or 3. Preferably, R may be methyl and y may be 2 or 3.

The prepolymer of the invention may exhibit a number average molecular weight (Mn) of 400 to 10,000, preferably 800 to 6,000, more preferably 1,000 to 5,000. The number average molecular weight may be determined by steric exclusion chromatography (SEC) or nuclear magnetic resonance (NMR).

The prepolymer of the invention may be obtained according to the method described below.

### Method for Preparing the Prepolymer of the Invention

The prepolymer of the invention may be obtained by a Michael addition. Michael addition is a chemical reaction in which an enolate anion (nucleophile) reacts with an activated α,β-unsaturated carbonyl compound (electrophile) according to a 1,4-addition. A wide range of functional groups possess sufficient nucleophilicity to react in a Michael addition, such as amines (aza-addition) and thiols (thio-addition). Michael addition is one of the most versatile reactions in organic synthesis with its click chemistry nature, no byproducts, and the mild conditions required for the reaction. An example of a Michael addition is represented in the scheme below:

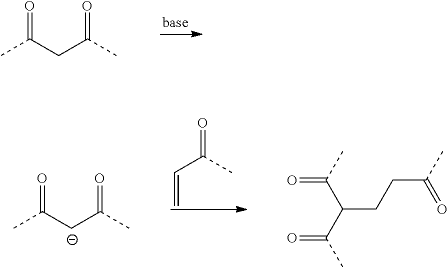

The first step of a Michael reaction is transforming a ketone to an enolate, or nucleophile, through deprotonation due to the addition of a base. This negative charge initiates 1,4-addition on an α,β-unsaturated carbonyl compound which is then protonated and forms the final product. The reaction is thermodynamically controlled as the donors are active methylenes and the acceptors are activated olefins.

In accordance with an aspect, a Michael addition reaction can be employed to manufacture silyl-terminated polymers useful for obtaining one-component moisture curable sealants, coatings or adhesives. The method involves reacting a polyamine or a polythiol with a silane comprising an α,β-unsaturated carbonyl group. The polyamine or polythiol are Michael donors and the silane comprising an α,β-unsaturated carbonyl group is a Michael acceptor.

The method for preparing a prepolymer according to the invention comprises reacting an electrophile of formula (3) with a polyamine or polythiol of formula (4):

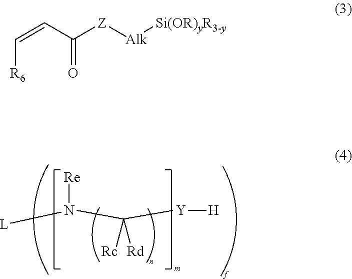

wherein L, Y, Z, R, R_{c}, R_{d}, Rₑ, R₆, Alk, f, n, m and y are as defined above for the prepolymer,
when Y is S or NR′ and R′ is not H, the molar ratio between the hydrogens on the amine or thiol reactive groups of the polyamine or polythiol and the α,β-unsaturated carbonyl groups of the electrophile is from 0.8 to 1.2, preferably 0.9 to 1.1, more preferably 0.95 to 1.05;
when Y is NH, the molar ratio between the hydrogens on the amine reactive groups of the polyamine and the α,β-unsaturated carbonyl groups of the electrophile is from 1.8 to 2.2, preferably 1.9 to 2.1, more preferably 1.95 to 2.05.

The electrophile of formula (3) may be represented by one of the following formulae (3a)-(3c)

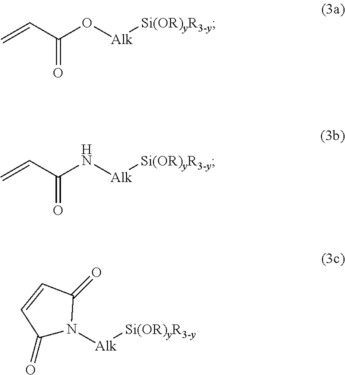

wherein
Alk is a linear or branched C1-C20 alkylene, preferably Alk is methylene, propylene or —(CH₂)—(CHCH₃)—(CH₂)—;
each R is independently C1-C20 alkyl, preferably R is methyl or ethyl, more preferably R is methyl; and
y is 0, 1, 2 or 3, preferably y is 2 or 3.

Preferably, the R group of the electrophile may be methyl or ethyl and y may be 2 or 3. More preferably, R may be methyl and y may be 2 or 3.

In a preferred embodiment, the electrophile may be represented by formula (3a).

An example of an electrophile of formula (3a) is (3-acryloxypropyl)trimethoxysilane (available under reference SiSiB® PC4600 or KBM-5103 by ShinEtsu and AY43-310M by Dowcorning) or (3-acryloxypropyl)methyldimethoxysilane (available under reference SIA0198.0 by Gelest or S2209 by Silar) or (3-acryloxymethyl)trimethoxysilane (available under reference SIA0182.0 by Gelest) which are represented below

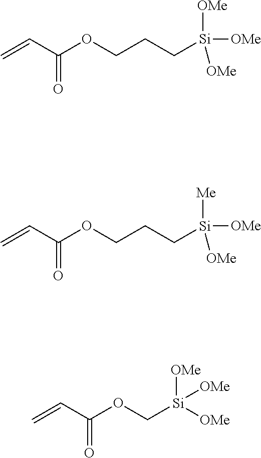

In a first embodiment, the polyamine of formula (4) may be represented by formula (4a)

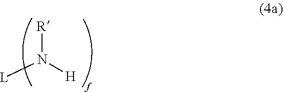

wherein L, R′ and f are as defined above.

In said first embodiment, R′ may be H, a C1-C20 alkyl optionally interrupted by one or more ester functional groups, a C6-C12 aryl or a C6-C12 alkylaryl, preferably R′ is H, methyl, ethyl, isopropyl, isobutyl, 1,2,2-trimethylpropyl, diethyl succinate, benzyl or phenyl.

In said first embodiment, L may be a linear or branched, cyclic or acyclic, saturated or unsaturated, aliphatic or aromatic, divalent or trivalent, hydrocarbyl radical comprising 1-500 carbon atoms, said radical being optionally interrupted by one more functional groups selected from ether, ester, amide, dimethylsiloxane and mixtures thereof, said radical optionally having one or more carbon atoms replaced with a nitrogen atom or an isocyanurate group, said radical being optionally substituted by one or more substituents selected from halogen, hydroxy, alkoxy, an ester group and mixtures thereof.

In formula (4a), L may preferably be represented by one of formulae (La)-(Lm) as defined above for the first embodiment of the prepolymer, more preferably L may be represented by one of formulae (Lg)-(Lk).

Examples of suitable polyamines according to the first embodiment are amino-terminated polyethers sold under the trademark Jeffamine® by HUNTSMAN. Particularly, the polyamine may belong to the Jeffamine® D, SD, ED, EDR, T or ST series. More preferably, the polyamine may be Jeffamine® D-4000 which corresponds to the following formula:

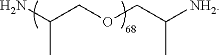

In a second embodiment, the polyamine of formula (4) may be represented by formula (4b):

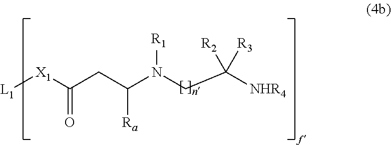

wherein
X₁ is O or NR_{b}, preferably X₁ is O;
L₁ is a plurivalent radical;
Rₐ is hydrogen;
R_{b} is hydrogen;
or Rₐ forms a cycle with R_{b}, preferably a succinimide;
R₁ and Rₐ are independently C1-C20 alkyl, C6-C12 aryl or C6-C12 alkylaryl, preferably methyl, ethyl, phenyl or benzyl, more preferably methyl;
or R₁ and R₄ form a cycle, preferably a piperazine, more preferably a piperazine optionally substituted with one or more groups selected from C1-C20 alkyl, C6-C12 aryl, C6-C12 alkylaryl, halogen, C1-C20 haloalkyl, C6-C12 haloaryl and C6-C12 haloalkylaryl, even more preferably a piperazine optionally substituted with one or more groups selected from methyl, ethyl, chloro, phenyl, chlorophenyl and benzyl, more preferably still substituted with methyl;
R₂ and R₃ are independently selected from H, C1-C20 alkyl, C6-C12 aryl, C6-C12 alkylaryl, halogen, C1-C20 haloalkyl, C6-C12 haloaryl or C6-C12 haloalkylary, preferably H, methyl, ethyl, chloro, phenyl, chlorophenyl or benzyl, more preferably H or methyl, with the proviso that at least one of R₂ and R₃ is not H;
2≤f′≤6, preferably 2≤f′≤4, more preferably 2≤f′≤3;
n′ is 1, 2, 3, 4, 5 or 6, preferably n′ is 1.

In formula (4b), L₁ may preferably be represented by one of formulae (L′a)-(L′m) as defined above for the second embodiment of the prepolymer.

Polyamines of formula (4b) are described in patent application number EP19305659.5 filed on May 24, 2019 by the Applicants.

In a third embodiment, the polyamine of formula (4) may be represented by formula (4c)

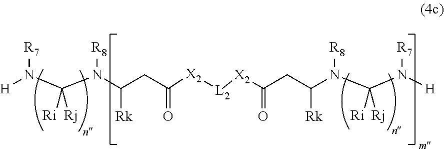

wherein
X₂ is O or NRᵢ, preferably X₂ is O;
each L₂ is independently a plurivalent radical;
Rᵢ is hydrogen;
Rⱼ is hydrogen;
or one Rⱼ forms a cycle with R₇, another Rⱼ forms a cycle with R₈ and the remaining Rᵢ are hydrogen, preferably one Rⱼ forms a piperidine with R₇, another Rⱼ forms a piperidine with R₈ and the remaining Rⱼ are hydrogen;
Rₖ is hydrogen;
Rₗ is hydrogen;
or Rₖ forms a cycle with Rₗ, preferably a succinimide;
R₇ and R₈ are independently selected from C1-C20 alkyl, C6-C12 aryl or C6-C12 alkylaryl, preferably methyl, ethyl, phenyl or benzyl, more preferably methyl;
or R₇ et R₈ form a cycle, preferably a piperazine, more preferably a non-substituted piperazine; or R₇ forms a cycle with one Rⱼ and R₈ forms a cycle with another Rⱼ, preferably R₇ forms a piperidine with one Rⱼ and R₈ forms a piperidine with another R₁;
n″ is 2, 3, 4, 5, 6, 7, 8 or 9;
1<m″≤10, preferably 1,5≤m″≤8, more preferably 2≤m″≤6.

Preferably, in formula (4c), each L2 may independently be represented by one of formulae (L′a)-(L′g2) and (L″h)-(L″m) as defined above for the second embodiment of the prepolymer.

Polyamines of formula (4c) are described in patent application number EP19305658.7 filed on May 24, 2009 by the Applicants.

Examples of suitable polyamines of formula (4c) are represented below:

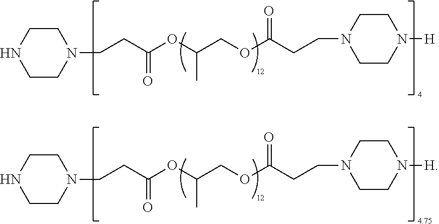

In a fourth embodiment, the polythiol may be represented by the following formula (5):

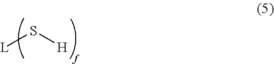

wherein L and f are as defined above.

In said fourth embodiment, L may be linear or branched, cyclic or acyclic, saturated or unsaturated, aliphatic or aromatic, divalent, trivalent or tetravalent, hydrocarbyl radical comprising 2 to 300 carbon atoms, said radical being optionally interrupted by one or more functional groups selected from ether, ester, thioether, disulfide and mixtures thereof, said radical being optionally substituted by one or more substituents selected from halogen, hydroxy, alkoxy and mixtures thereof.

Preferably, the L group of the polythiol of formula (5) may be represented by one of formulae (Ln)-(Lv) as defined above for the third embodiment of the prepolymer.

Examples of suitable polythiols according to the fourth embodiment are sold under reference Thioplast® by Nouryon.

In the method of the invention, the reaction between the electrophile and the polyamine or polythiol may be carried out in the presence or in the absence of a solvent. Preferably, the reaction between the electrophile and the polyamine or polythiol may be carried out in the absence of a solvent.

In the method of the invention, the reaction between the electrophile and the polyamine or polythiol may be carried out in the presence or in the absence of a catalyst. When the electrophile reacts with a polyamine, the reaction between the electrophile and the polyamine may be carried out in the absence of catalyst. When the electrophile reacts with a polythiol, the reaction between the electrophile and the polythiol may be carried out in the presence of a catalyst. In particular, said catalyst may be a base, more particularly 1,4-diazabicyclo[2.2.2]octane (DABCO) or 1,8-diazabicyclo[5.4.0]undec-7-ene (DBU).

In the method of the invention, the reaction between the electrophile and the polyamine or polythiol may be carried out at a temperature of 10 to 60° C., in particular 15 to 50° C., more particularly 20 to 40° C., during a time of 5 min to 4 h, in particular 15 min to 2 h, more particularly 30 min to 1 h.

The completion of the reaction may be monitored by Fourier-transform infrared (FT IR) spectroscopy. FT IR spectroscopy works by sending infrared radiation through a chemical sample, where some radiation is absorbed into the sample and some passes through. The radiation that is absorbed is converted to vibrational energy, which produces a unique signal that identifies the compound. During the Michael addition, the carbon-carbon double bond of the electrophile is transformed into a carbon-carbon single bond. Once the FT IR signal of the carbon-carbon double bond disappears, the reaction may be considered as finished. The reaction may alternatively be monitored by Proton Nuclear Magnetic Resonance (¹H-NMR). Once the α,β-unsaturated carbonyl group has reacted, the signals of the ethylenic protons (between 5.8 and 6.5 ppm) are no longer visible and a new signals relative to single bonds CH₂—CH₂ are present.

By contrast, a methacryloxypropyltrimethoxy silane as used in the prior art cannot be used for preparing the prepolymer of the present invention since a methacryloxypropyltrimethoxy silane does not react with amine compounds by Michael aza-addition. In particular, methacrylate compounds are not reactive with amine compounds by Michael aza-addition since they are not sufficiently electrophilic.

### Composition Comprising a Prepolymer

The composition according to the invention comprises the prepolymer of the invention and an additive. The composition may further optionally comprise a resin and/or a catalyst.

The prepolymer introduced in the composition of the invention is as defined above. The composition may comprise a mixture of prepolymers according to the invention. The composition may comprise a mixture of a prepolymer according to the invention and a silyl-terminated prepolymer not according to the present invention.

The amount of the one or prepolymers according to the invention in the composition may be from 20 to 60%, in particular 25 to 55%, more particularly 30 to 50%, by weight based on the weight of the composition.

The additive introduced in the composition of the invention is a conventional additive used in the manufacture of sealants, coatings and adhesives. The composition may comprise a mixture of additives. The additive introduced in the composition of the invention is selected from a plasticizer, a filler, an adhesion promoter, a pigment or dye, a UV-absorber, an antioxidant, a UV-stabilizer, a moisture scavenger, a fungicide, a biocide, a root-penetration preventer, a fire-retardant, a rheology modifier, an oxygen barrier and mixtures thereof.

Examples of suitable plasticizers are aromatic oils, such as diisopropyl naphthalene (Ruetasolv® DI) or NYTEX® 820; esters of polycarboxylic acids with linear or branched aliphatic alcohols, such as phthalates and adipates, for example dioctyl phthalate (DOP), diisodecyl phthalate (DIDP), diisononyl phthalate (DINP), butylbenzyl phthalate and di(2-ethylhexyl)adipate (DEHA); esters of polyols with linear or branched carboxylic acids, such as trimethyl pentanediol diisobutyrate (TXIB); alkylsulfonic acid phenylesters, such as Mesamoll®; and mixtures thereof.

Examples of suitable fillers are mineral or organic fillers, such as calcium carbonate, silica, talc, dolomite, kaolin, carbon black, titanium dioxide, and mixtures thereof. Preferably, said filler is calcium carbonate. Fillers derived from recycling can also be used (lignin, recycled fibers, ground polymer materials, coke, ground cement materials).

Examples of suitable biocides and fungicides are 2-octyl-2H-isothiazol-3-one (OIT) in diisododecylphthalate (Fungitrol® PA10), N-(Trichloromethylthio) phthalimide (Fungitrol® 11), 3-iodo-2-propynyl butylcarbamate (IPBC) (Fungitrol® 0450 or Preventol® MP100).

An example of a suitable root-penetration preventer is 2-(4-chloro-2-methylphenoxy)-propionic acid octyl ester (Preventol® B5).

Examples of suitable UV-absorbers and antioxidants are Irganox® 565 (2,4-Bis(octylthio)-6-(4-hydroxy-3,5-di-tert-butylanilino)-1,3,5-triazine), IONOL® CP (2,6-Di-tert-butyl-4-methylphenol), Tinuvin® 1130 (2-(2-hydroxyphenyl)-benzotriazole), Tinuvin® 400 (2-hydroxyphenyl-s-triazine).

Examples of suitable UV-stabilizers are Tinuvin® 292 ((Bis(1,2,2,6,6-pentamethyl-4-piperidyl) sebacate), Tinuvin® 123 (Bis(1-octyloxy-2,2,6,6-tetramethyl-4-piperidyl) sebacate).

Examples of suitable moisture scavenger and adhesion promoters are silanes, such as vinyltrimethoxysilane (Geniosil® XL 10) and N-(2-Aminoethyl)-3-aminopropyltrimethoxysilane (Geniosil® GF91).

Examples of suitable rheology modifiers are a hydrophobically modified alkali swellable emulsion (HASE) such as Acrysol® TT 935 and Acrysol® DR-110 ER; a cellulose or cellulose derivative such as CMC, HMC, HPMC; a polysaccharide such as carrageenan, pullulan, konjac, and alginate; a clay such as attapulgite, bentonite and montmorillonite; a gum such as guar gum, xanthan gum, cellulose gum, locust bean gum, and acacia gum.

Examples of suitable fire retardants are borates, such as colemanite, halogenated compounds (tris(chloropropyl)phosphate=TCPP or tetrabromobisphenol-A=TBBA or Hexabromocyclododecane=HBCD), triaryl phosphate, melamine (non-halogenated flame retardant), alumina trihydrate, DOPO (9,10-dihydro-9-oxa-10-phosphaphenanthrene-10-oxide=Polyphlox® 3710.

An example of a suitable oxygen barrier is a wax, such as paraffin wax (Sasolwax® 5603).

The amount of the additive in the composition may be from 40 to 80%, in particular 45 to 75%, more particularly 50 to 70%, by weight based on the weight of the composition.

The composition may comprise a resin. The resin that may optionally be introduced in the composition may be selected from a multifunctional epoxy resin, a multifunctional isocyanate resin, a multifunctional (meth)acrylate resin, a multifunctional acrylamide resin, a multifunctional maleimide resin, a poly(meth)acrylate resin, a polyacrylamide resin, a polymaleimide resin, and mixtures thereof. Preferably, the resin is a multifunctional epoxy resin, more preferably a diepoxide resin derived from a bisphenol. Even more preferably, the resin is bisphenol A diglycidyl ether epoxy resin which has the following formula:

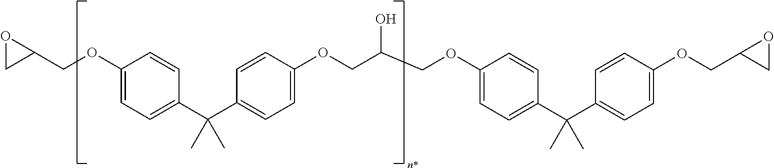

wherein n* is typically from 0 to 25.

The amount of resin in the composition may be from 0 to 20%, in particular 2 to 15%, more particularly 5 to 10%, by weight based on the weight of the composition.

The composition may comprise a catalyst. Said catalyst may be introduced in the composition to promote cross-linking of the silyl groups of the prepolymers in the presence of atmospheric moisture. The catalyst that may optionally be introduced in the composition may be selected from a tertiary amine, an organometallic compound, an acid, an anhydride, and mixtures thereof. Preferably, the catalyst is a metal carboxylate (tin, zinc, iron, lead, copper or titanium carboxylate such as dibutyltin dilaurate (DBTDL), dioctyltin dilaurate, dioctyltin acetylacetonate, copper acetylacetonate, isopropyl triisostearoyl titanate), a carboxylic or sulfonic acid (stearic acid, palmitic acid, oleic acid, 4-dodecylbenzene sulfonic acid, dinonylnaphthalene disulfonic acid, p-toluenesulfonic acid (p-TSA), methanesulfonic acid), a tertiary cyclic amine (1,8-diazabicyclo[5.4.0]undec-7-ene (DBU), 1,5-Diazabicyclo[4.3.0]non-5-ene (DBN), 1,4-diazabicyclo[2.2.2]octane (DABCO)) or an anhydride (methyltetrahydrophthalic anhydride (MHTPA), methylnadic anhydride and methylsuccinic anhydride). Even more preferably, the catalyst is DBU or DBTDL.

The amount of catalyst in the composition may be from 0 to 2%, in particular 0.01 to 1%, more particularly 0.1 to 0.8%, by weight based on the weight of the composition.

In one embodiment, the composition of the invention comprises the following constituents, the % being % by weight based on the weight of the composition:

30-50% of the prepolymer of the invention;
10-30% of a plasticizer, in particular diisodecyl phthalate (DIDP);
30-50% of a filler, in particular calcium carbonate;
0-2% of a moisture scavenger, in particular vinyltrimethoxysilane;
0-5% of an adhesion promoter, in particular N-(2-Aminoethyl)-3-aminopropyltrimethoxysilane;
0-2% of a catalyst, in particular dibutyltin dilaurate (DBTDL);
0-10% of a pigment or dye.

The composition of the invention may advantageously be a liquid one-component moisture curable composition. Also, the composition of the invention may be a stable composition. Further, the composition of the invention may be a non-toxic composition. Additionally, the composition of the invention may have a low solvent content, i.e. less than 5%, in particular less than 2%, more particularly less than 1%, by weight of solvent based on the weight of the composition, or the composition may be substantially free of any solvent.

The composition of the invention may be used to obtain a sealant, coating or adhesive.

### Sealant, Coating or Adhesive

The sealant, coating or adhesive of the invention is obtained by curing the composition according to the present invention.

The curing may be carried out rapidly under ambient conditions, in the presence of atmospheric moisture. In one embodiment, the curing may be carried out at a temperature of −10 to 50° C., in particular −5 to 45° C., more particularly 0 to 40° C., during a time of 1 to 72 h, in particular 2 to 30 h, more particularly 3 to 24 h.

The sealant, coating or adhesive according to the invention may exhibit a glass transition temperature of −120 to 80° C., preferably −100 to 60° C., more preferably −80 to 50° C.

The sealant, coating or adhesive according to the invention may exhibit excellent mechanical properties. As such, the sealant, coating or adhesive may exhibit a tensile strength at 20° C. of 0.1 to 100 MPa, preferably 1 to 50 MPa, more preferably 5 to 20 MPa. Further, the sealant, coating or adhesive may exhibit an elongation at break at 20° C. of 10 to 1,000%, preferably 50 to 800%, more preferably 100 to 600%.

### Use of the Composition

The invention also relates to the use of the composition according to the invention for producing a sealant, coating or adhesive, especially a leaktight sealant or coating, which has good mechanical strength, is resistant to UV, to oxidation aging, to water and to chemical attack, and which does not have any surface defects or adhesion defects (bubbles, swelling or exudation). The sealants or coatings may be circulable and are particularly suitable for use in an unprotected exterior medium as leaktight sealants or coatings. The sealants, coatings or adhesives obtained have an entirely satisfactory water uptake, i.e. less than 8% after 28 days of immersion in water at 20° C. The sealants, coatings or adhesives obtained by the use of the composition according to the invention can cover horizontal, oblique, vertical or rough surfaces and/or surfaces comprising singular points.

The composition of the invention may be used for waterproofing exterior or interior traffic-bearing horizontal surfaces, for making flashings, or for renovating roofs.

In one embodiment, the composition of the invention may be used for waterproofing exterior circulable horizontal surfaces, such as, for example, balconies, stadiums, terraces, car parks, building courtyards, etc.

In another embodiment, the composition of the invention may be used for making upstand flashings, i.e. for making a waterproof coating between a bituminous surface and a vertical wall or a singular point, or alternatively for renovating roofs.

In another embodiment, the composition of the invention may be used to bind two elements together.

The invention will be described in greater detail with the aid of the examples that follow, which are given for purely illustrative purposes.

### Examples

### Measuring Methods:

In the examples, the following methods were used to determine the glass transition temperature (Tg), the ultimate tensile strength, the Young's modulus and the elongation at break.

### Glass Transition Temperature

The glass transition temperature is determined on a dry material at least 7 days after its preparation by differential scan calorimetry (DSC). The DSC analyses were performed on a 10 mg sample using a Q200 apparatus from TA Instruments. The following cycles were applied:

Cycle 1: temperature increase from room temperature to 170° C. at 10° C./min and remaining at 170° C. for 5 min;
Cycle 2: temperature decrease to −80° C. at 20° C./min and remaining at −80° C. for 5 min;
Cycle 3: temperature increase to 170° C. at 10° C./min.

The Tg was measured during the third cycle.

### Mechanical Analysis:

The mechanical analyses were determined on a dry material 7 days after its preparation according to standard NF EN ISO 527, February 2012 on an extensometer from Instron. The following parameters were used:

tensile speed: 100 mm/min
temperature: 23° C.
test specimen: dumbbell-shaped type 5.

### Materials:

In the examples, the following materials were used:

Jeffamine® D-4000 (polyetheramine comprising two primary amine groups) having a number average molecular weight of about 4000 g·mol⁻¹ was obtained from Huntsman;

Acryloxypropyltrimethoxysilane and acryloxypropylmethyldimethoxysilane were obtained from Gelest;

PPGDA (polypropyleneglycol diacrylate) having a number average molecular weight of 840 g·mol⁻¹ was obtained from Sigma-Aldrich; Piperazine was obtained from Sigma-Aldrich;

Calcium carbonate (filler) was obtained from The Cary Company under reference Ultra-Pflex or from Omya under reference Omya® BLH;

1,2-cyclohexane dicarboxylic acid diisononyl ester (plasticizer) was obtained from BASF under reference Hexamoll® DINCH;

DIDP (diisodecyl phthalate—plasticizer) was obtained from Flag S.p.A.;

N-(2-Aminoethyl)-3-aminopropyltrimethoxysilane (adhesion promoter) was obtained from Wacker under reference Geniosil® GF 91 or from Momentive under reference Silquest® A-1120;

Vinyltrimethoxysilane (moisture scavenger) was obtained from Wacker under reference Geniosil® XL 10 or from Momentive under reference Silquest® A-171;

DBTDL (dibutyltin dilaurate) was obtained from LANXESS.

### Example 1: Preparation of a Silyl Terminated Prepolymer

Jeffamine® D-4000 (94.7 g, 0.024 mol) and acryloxypropylmethyldimethoxysilane (10.33 g, 0.047 mol) were mixed in a reactor under nitrogen atmosphere, without any solvent or catalyst. The mixture was stirred at 55° C. for 8 hours. The reaction was considered complete when the IRTF peak corresponding to the acrylate group disappeared (C═C stretch, 1530 cm⁻¹). The resulting product (105 g) was a colorless liquid.

### Example 2: Preparation of a Silyl Terminated Prepolymer

### Step 1) Preparation of a Piperazine Terminated Prepolymer of Formula (1)

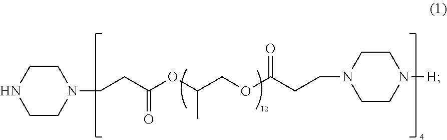

Piperazine (12.1 g, 0.140 mol) and PPGDA (94.6 g, 0.113 mol) were mixed in a 250 mL flask. The mixture was stirred at 80° C. for 1 hour. The resulting product was a colorless liquid with low viscosity. The reaction was considered complete when the NMR peaks corresponding to the ethylenic protons <<CH₂═CH₂)>> of the acrylate disappeared (between 5.8 ppm and 6.5 ppm).

NMR analysis confirmed that the resulting product was a prepolymer of PPGDA and piperazine with terminal piperazine NH groups. The number average molecular weight was determined by NMR.

NMR-¹H: (δ ppm, CDCl₃) 1.00-1.35 (148H), 1.80 (2H), 2.30-2.60 (46H), 2.62-2.76 (18H), 2.82-2.92 (8H), 3.25-3.75 (140H), 4.95-5.15 (8H).

The average number of repeating units was 4. The number average molecular weight was determined to be about 3,750 g·mol⁻¹.

### Step 2) Michael Addition to Obtain a Silyl Terminated Prepolymer of Formula (2)

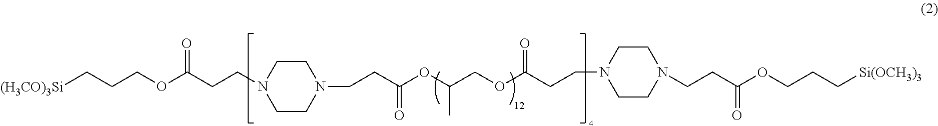

The piperazine terminated prepolymer obtained in step 1 (49.3 g, 13 mmol) was mixed with acryloxypropyltrimethoxysilane (6.2 g, 0.026 mol) in a reactor under nitrogen atmosphere. The mixture was stirred at 80° C. for 4 hours. The resulting product was a viscous colorless liquid. The reaction was considered complete when the NMR peaks corresponding to the terminal <<CH₂—NH>> groups disappeared (between 2.82 ppm and 2.92 ppm).

NMR analysis confirmed that the structure of resulting product corresponded to formula (2).

NMR-¹H: (δ ppm, CDCl₃) 0.67 (4H), 1.00-1.35 (146H), 1.70-1.80 (4H), 2.25-2.75 (55H), 2.62-2.76 (21H), 3.25-3.75 (154H), 4.06 (4H), 4.95-5.15 (8H).

### Example 3: Preparation of a Silyl Terminated Prepolymer

### Step 1) Preparation of a Piperazine Terminated Prepolymer of Formula (3)

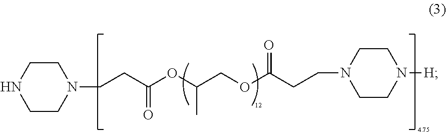

The prepolymer of formula (3) was obtained according to step 1) of example 2 using piperazine (6.0 g, 69.7 mmol) and PPGDA (48.9 g, 61.1 mmol). The average number of repeating units was 4.75. The number average molecular weight was determined to be about 4,200 g·mol⁻¹.

### Step 2) Michael Addition to Obtain a Silyl Terminated Prepolymer of Formula (4)

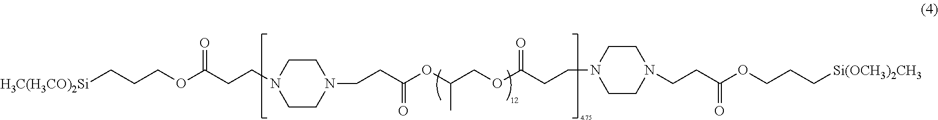

The piperazine terminated prepolymer obtained in step 1 (54.9 g, 13.0 mmol) was mixed with acryloxypropylmethyldimethoxysilane (5.6 g, 0.026 mol) in a reactor under nitrogen atmosphere. The mixture was stirred at 60° C. for 4 hours. The resulting product was a colorless liquid with low viscosity. The reaction was considered complete when the NMR peaks corresponding to the terminal <<CH₂—NH>> groups disappeared (between 2.82 ppm and 2.92 ppm).

NMR analysis confirmed that the structure of resulting product corresponded to formula (3).

NMR ¹H: (δ ppm, CDCl₃) 0.10-0.15 (6H), 0.64 (4H), 1.00-1.35 (156H), 1.70-1.80 (4H), 2.25-2.75 (71H), 2.62-2.76 (27H), 3.25-3.75 (153H), 4.06 (4H), 4.95-5.15 (9H).

### Example 4: Preparation of Sealant Composition

Compositions 1 to 3 were prepared using the ingredients and the respective amounts in grams listed in the following table:

| | Composition 1 | Composition 2 | Composition 3 |
|---|---|---|---|
| Silyl terminated | Prepared in Example 1 | Prepared in Example 2 | Prepared in Example 3 |
| prepolymer | (68.7 g) | (39.9 g) | (40.1 g) |
| Filler | Ultra-Pflex ® | Omya ® BLH | Omya ® BLH |
| | (86.2 g) | (49.9 g) | (50.6 g) |
| Plasticizer | Hexamoll ® DINCH | DIDP | DIDP |
| | (36.9 g) | (21.5 g) | (21.4 g) |
| Adhesion | Silquest ® A-1120 | Geniosil ® GF 91 | Geniosil ® GF 91 |
| promoter | (4.9 g) | (2.9 g) | (2.9 g) |
| Moisture | Silquest ® A-171 | Geniosil ® XL10 | Geniosil ® XL10 |
| scavenger | (2.5 g) | (1.4 g) | (1.4 g) |
| Catalyst | DBTDL | DBTDL | DBTDL |
| | (0.8 g) | (0.5 g) | (0.6 g) |

The silyl terminated prepolymer and plasticizer were mixed in a disperser and stirred for 10 minutes. The filler, adhesion promoter and moisture scavenger were then added and the mixture was stirred for 15 minutes. The catalyst was then added and the mixture was stirred for 10 minutes. The composition was casted on a plate in order to obtain a uniform film having a thickness of about 1 mm and was left to dry during 7 days.

The thermal and mechanical properties of the resulting sealants are listed in the table below:

| | Composition 1 | Composition 2 | | Composition 3 | |
|---|---|---|---|---|---|
| Ultimate Tensile strength (MPa) | 1.15 | 0.66 | (+/−0.05) | 0.77 | (+/−0.05) |
| Young's Modulus (MPa) | — | 2.40 | (+/−0.45) | 1.71 | (+/−0.50) |
| Elongation at break (%) | 196 | 84 | (+/−8) | 130 | (+/−5) |

| | | | |
|---|---|---|---|
| Tg (° C.) | — | −60 | −62 |

1. A prepolymer represented by formula (1): 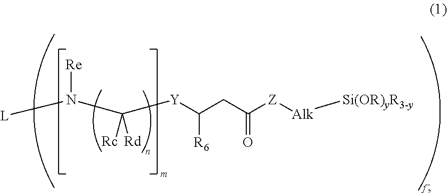
wherein
L is a plurivalent radical;
Y is NR′ or S, preferably Y is NR′;
Z is O or NR₅, preferably Z is O;
R₅ is hydrogen;
R₆ is hydrogen;
or R₅ forms a cycle with R₆, preferably a succinimide;
each R_{c} is independently H, a C1-C20 alkyl, a C6-C12 aryl or a C6-C12 alkylaryl, preferably H, methyl, ethyl, phenyl or benzyl, more preferably H or methyl;
each R_{d} is independently H, a C1-C20 alkyl, a C6-C12 aryl or a C6-C12 alkylaryl, preferably H, methyl, ethyl, phenyl or benzyl, more preferably H or methyl;
or one R_{d} forms a cycle with R′, another R_{d} forms a cycle with Rₑ and the remaining R_{d} are H, a C1-C20 alkyl, a C6-C12 aryl or a C6-C12 alkylaryl, preferably one R_{d} forms a piperidine with R′, another R_{d} forms a piperidine with Rₑ and the remaining R_{d} are H, a C1-C20 alkyl, a C6-C12 aryl or a C6-C12 alkylaryl, more preferably one R_{d} forms a piperidine with R′, another R_{d} forms a piperidine with Rₑ and the remaining R_{d} are H or methyl;
Rₑ is H, a C1-C20 alkyl, a C6-C12 aryl or a C6-C12 alkylaryl, preferably Rₑ is H, methyl, ethyl, butyl, cyclohexyl or phenyl;
R′ is H, a C1-C20 alkyl optionally interrupted by one or more ester functional groups, a C6-C12 aryl or a C6-C12 alkylaryl, preferably R′ is H, methyl, ethyl, isopropyl, isobutyl, 1,2,2-trimethylpropyl, diethyl succinate, benzyl or phenyl;
or R′ and Rₑ form a cycle, preferably a piperazine optionally substituted by one or more groups selected from C1-C20 alkyl, C6-C12 aryl and C6-C12 alkylaryl;
or R′ forms a cycle with one R_{d} and Rₑ forms a cycle with another R_{d}, preferably R′ forms a piperidine with one R_{d} and Rₑ forms a piperidine with another R_{d};
Alk is a linear or branched C1-C20 alkylene, preferably Alk is methylene, propylene or —(CH₂)—(CHCH₃)—(CH₂)—;
each R is independently C1-C20 alkyl, preferably R is methyl or ethyl, more preferably R is methyl;
f is 2 to 6, preferably 2 to 4, more preferably 2 to 3;
m is 0 or 1;
n is 2, 3, 4, 5, 6, 7, 8 or 9, preferably n is 2; and
y is 0, 1, 2 or 3, preferably y is 2 or 3.

2. The prepolymer of claim 1, wherein the prepolymer is represented by one of the following formulae (1a)-(1c): 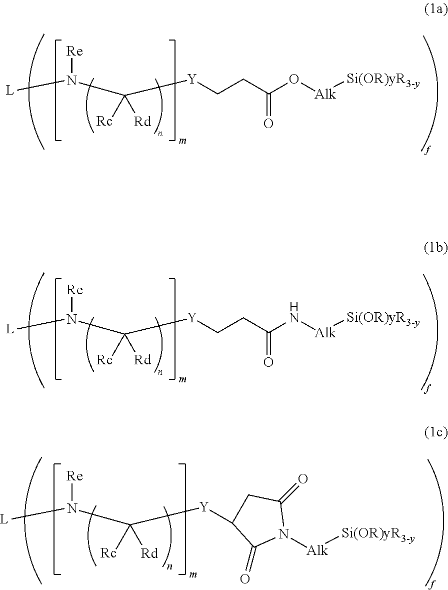
wherein L, Y, R, Rₑ, Rₑ, R_{d}, Alk, f, m, n and y are as defined in claim 1;
preferably the prepolymer is represented by formula (1a).

3. The prepolymer of claim 1, wherein L is a linear or branched, cyclic or acyclic, saturated or unsaturated, aliphatic or aromatic, plurivalent hydrocarbyl radical containing 1 to 500 carbon atoms, said radical being optionally interrupted by one or more functional groups selected from ether (—O—), thioether (—S—), disulfide (—S—S—), ester (—C(O)—O—), amide (—C(O)—NH—), carbamate (—NH—C(O)—O—), urea (—NH—C(O)—NH—), dimethylsiloxane (—Si(Me)₂-O—) and mixtures thereof, said radical optionally having one or more carbon atoms replaced by a nitrogen atom or an isocyanurate group having the following formula: 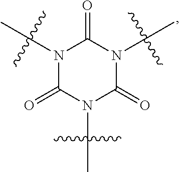 [SMILES: *n1c(=O)n(*)c(=O)n(*)c1=O]
said radical being optionally substituted by one or more substituents selected from halogen, alkyl, aryl, hydroxy (—OH), alkoxy (—OR₁₈), haloalkyl, cyano (—CN), carboxyl (—COOH), oxo (═O), formyl (—CHO), ester (—COOR₁₈), imido (═NR₁₈), amido (—CONHR₁₈), a tertiary amino group (—N(R₁₈)₂), nitro (—NO₂), sulfonyl (—SO₂—R₁₈) and mixtures thereof, wherein each R₁₈ is independently C1-C20 alkyl, C6-12 aryl or C6-C12 alkylaryl group.

4. The prepolymer of claim 1, wherein
Y is NR′;
m is 0;
R′ is H, a C1-C20 alkyl optionally interrupted by one or more ester functional groups, a C6-C12 aryl or a C1-C20 alkylaryl, preferably R′ is H, methyl, ethyl, isopropyl, isobutyl, 1,2,2-trimethylpropyl, diethyl succinate, benzyl or phenyl; and
L is a linear or branched, cyclic or acyclic, saturated or unsaturated, aliphatic or aromatic, divalent or trivalent, hydrocarbyl radical comprising 1-500 carbon atoms, said radical being optionally interrupted by one more functional groups selected from ether, ester, amide, dimethylsiloxane, and mixtures thereof, said radical optionally having one or more carbon atoms replaced with a nitrogen atom or an isocyanurate group, said radical being optionally substituted by one or more substituents selected from halogen, hydroxy, alkoxy, an ester group and mixtures thereof;
preferably L is selected from one of formulae (La)-(Lm): 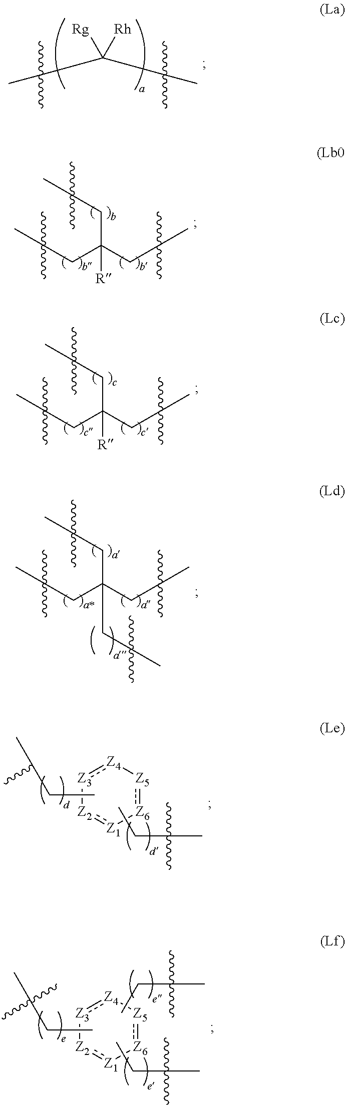 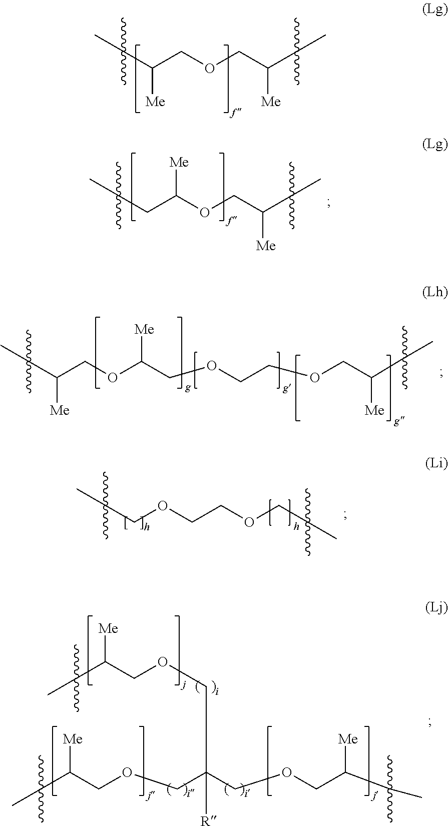 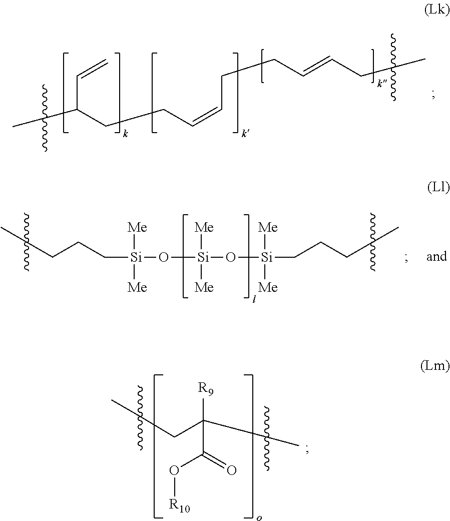
wherein
Z₁, Z₂, Z₃, Z₄, Z₅ and Z₆ are independently CRₓR_{y} or NR_{z};
R″ is H or C1-C20 alkyl optionally substituted by OH or alkoxy;
R₉ is H or methyl;
R₁₀ is C1-C20 alkyl;
R_{g} and Rₕ are independently H or C1-C20 alkyl;
Rₓ, R_{y} and R_{z} are independently absent, H or C1-C20 alkyl;
the dashed lines represent a single or double bond;
a is 2 to 12;
a′, a″, a′″, a*, b, b′, b″, c, c′ and c″ are independently 0 to 6;
d, d′, e, e′ and e″ are independently 0 to 3;
f″ is 2 to 100;
g′ is 2 to 50 and g+g″ is 1 to 10;
h is 2 to 10;
i′ and i″ are independently 0 to 3;
j+j′+j″ is 5 to 100;
k, k′ and k″ are independently 0 to 50;
l is 5 to 150; and
o is 1 to 100;
more preferably L is selected from one of formulae (Lg)-(Lk).

5. The prepolymer of claim 1, wherein the prepolymer is represented by formula (1d): 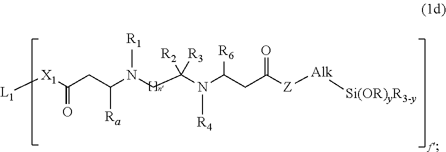
wherein
Z, Alk, R, R₆ and y are as defined in claim 1;
X₁ is 0 or NR_{b}, preferably X₁ is 0;
L₁ is a plurivalent radical;
Rₐ is hydrogen;
R_{b} is hydrogen;
or Rₐ forms a cycle with R_{b}, preferably a succinimide;
R₁ and R₄ are independently C1-C20 alkyl, C6-C12 aryl or C6-C12 alkylaryl, preferably methyl, ethyl, phenyl or benzyl, more preferably methyl;
or R₁ and R₄ form a cycle, preferably a piperazine, more preferably a piperazine optionally substituted with one or more groups selected from C1-C20 alkyl, C6-C12 aryl, C6-C12 alkylaryl, halogen, C1-C20 haloalkyl, C6-C12 haloaryl and C6-C12 haloalkylaryl, even more preferably a piperazine optionally substituted with one or more groups selected from methyl, ethyl, chloro, phenyl, chlorophenyl and benzyl, more preferably still substituted with methyl;
R₂ and R₃ are independently selected from H, C1-C20 alkyl, C6-C12 aryl, C6-C12 alkylaryl, halogen, C1-C20 haloalkyl, C6-C12 haloaryl or C6-C12 haloalkylaryl, preferably H, methyl, ethyl, chloro, phenyl, chlorophenyl or benzyl, more preferably H or methyl, with the proviso that at least one of R₂ and R₃ is not H;
2≤f′≤6, preferably 2≤f′≤4, more preferably 2≤f′≤3;
n′ is 1, 2, 3, 4, 5 or 6, preferably n′ is 1.

6. The prepolymer of claim 1, wherein the prepolymer is represented by formula (1e): 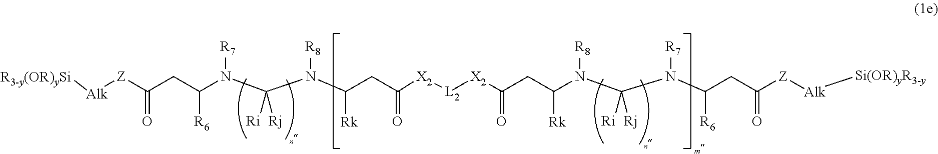
wherein
Z, Alk, R, R₆, and y are as defined in claim 1;
X₂ is O or NR₁, preferably X₂ is O;
each L2 is independently a plurivalent radical;
Rᵢ is hydrogen;
Rⱼ is hydrogen;
or one Rⱼ forms a cycle with R₇, another Rⱼ forms a cycle with R₈ and the remaining Rⱼ are hydrogen, preferably one Rⱼ forms a piperidine with R₇, another Rⱼ forms a piperidine with R₈ and the remaining Rⱼ are hydrogen;
Rₖ is hydrogen;
Rₗ is hydrogen;
or Rₖ forms a cycle with Rₗ, preferably a succinimide;
R₇ and R₈ are independently selected from C1-C20 alkyl, C6-C12 aryl or C6-C12 alkylaryl, preferably methyl, ethyl, phenyl or benzyl, more preferably methyl;
or R₇ and R₈ form a cycle, preferably a piperazine, more preferably a non-substituted piperazine;
or R₇ forms a cycle with one Rⱼ and R₈ forms a cycle with another Rⱼ, preferably R₇ forms a piperidine with one Rⱼ and R₈ forms a piperidine with another Rⱼ;
n″ is 2, 3, 4, 5, 6, 7, 8 or 9;
1≤m″≤10, preferably 1,5≤m″≤8, more preferably 2≤m″≤6.

7. The prepolymer claim 1, wherein
Y is S;
m is 0; and
L is a linear or branched, cyclic or acyclic, saturated or unsaturated, aliphatic or aromatic, divalent, trivalent or tetravalent, hydrocarbyl radical comprising 2 to 300 carbon atoms, said radical being optionally interrupted by one or more functional groups selected from ether, ester, thioether, disulfide and mixtures thereof, said radical being optionally substituted by one or more substituents selected from hydroxy, alkoxy and mixtures thereof;
preferably L is represented by one of formulae (Ln)-(Lv): 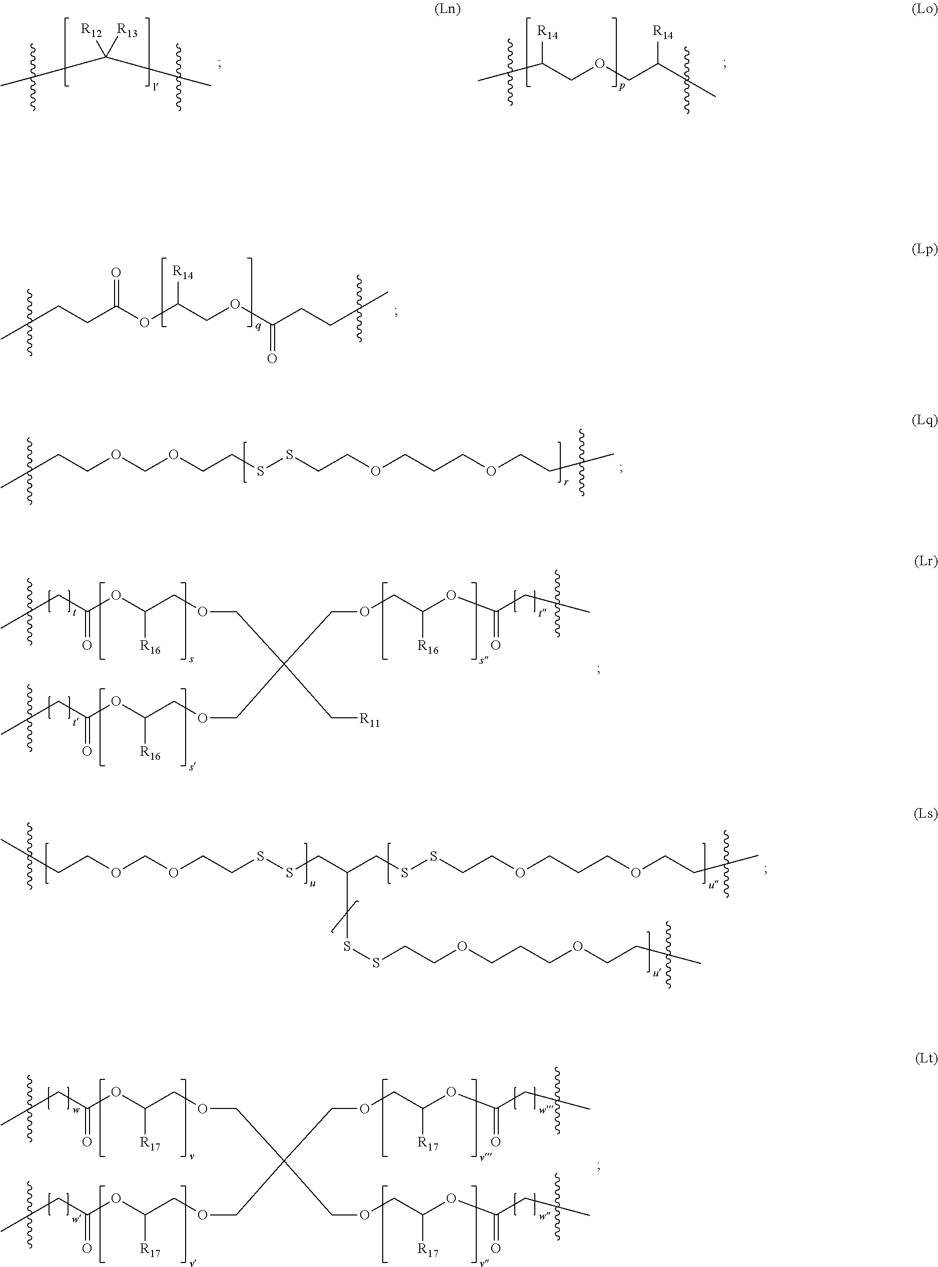 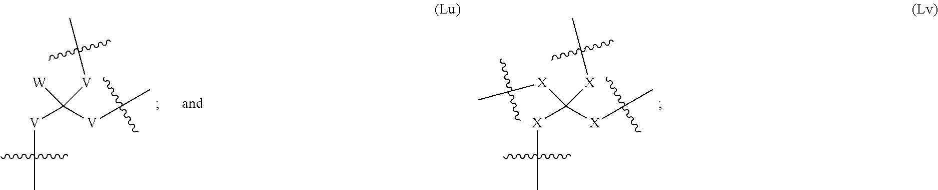
wherein
R₁₁ is H or C1-C20 alkyl optionally substituted by hydroxy or alkoxy;
R₁₂ and R₁₃ are independently H or C1-C20 alkyl;
each R₁₄, R₁₅, R₁₆ and R₁₇ is independently H or methyl;
each V is independently a linear or branched alkylene comprising 0 to 100 carbon atoms optionally interrupted by one or more ether functional groups;
W is H or C1-C20 alkyl optionally substituted by hydroxy or alkoxy;
each X is independently a linear or branched alkylene comprising 0 to 100 carbon atoms optionally interrupted by one or more ether functional groups;
p, q, r, u, u′ and u″ are independently 1 to 100;
s, s′, s″, v, v′, v″ and v′″ are independently 0 to 100; and
t, t′, t″, w, w′, w″ and w″ are independently 1 or 2.

8. The prepolymer claim 1, wherein R is methyl or ethyl and y is 2 or 3, preferably R is methyl and y is 2 or 3.

9. A method for preparing a prepolymer, wherein said method comprises reacting an electrophile of formula (3) with a polyamine or polythiol of formula (4): 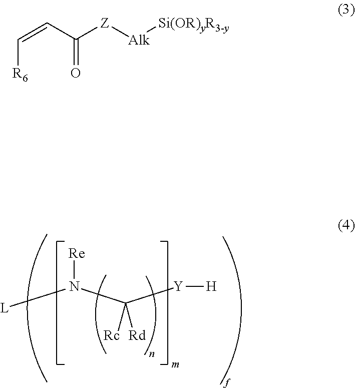
wherein L, Y, Z, R, R_{c}, R_{d}, Rₑ, R₆, Alk, f, n, m and y are as defined claim 1,
when Y is S or NR′ and R′ is not H, the molar ratio between the hydrogens on the amine or thiol reactive groups of the polyamine or polythiol and the α,β-unsaturated carbonyl groups of the electrophile is from 0.8 to 1.2, preferably 0.9 to 1.1, more preferably 0.95 to 1.05;
when Y is NH, the molar ratio between the hydrogens on the amine reactive groups of the polyamine and the α,β-unsaturated carbonyl groups of the electrophile is from 1.8 to 2.2, preferably 1.9 to 2.1, more preferably 1.95 to 2.05.

10. The method of claim 9, wherein the electrophile is represented by one of the following formula (3a)-(3c) 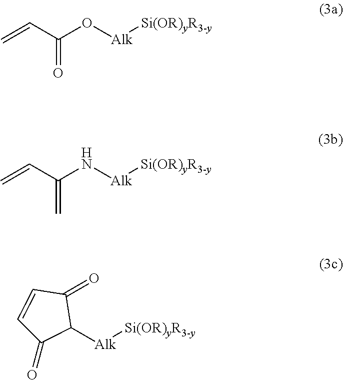
wherein Alk, R and y are as defined in claim 1,
preferably the electrophile is represented by formula (3a).

11. The method of claim 9, wherein the polyamine is represented by one of the following formula (4a)-(4c) and the polythiol is represented by the following formula (5) 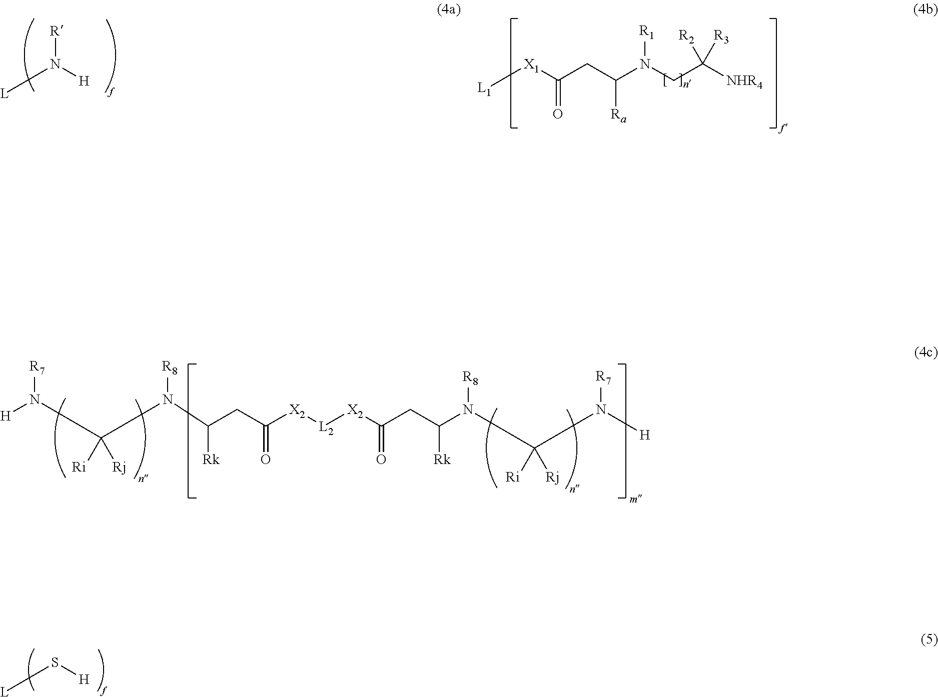
wherein
in formula (4a) L, R′ and f are as defined in any one of claims 1 to 4;
in formula (4b) L₁, X₁, Rₐ, R₁, R₂, R₃, R₄, f′ and n′ are as defined in claim 5;
in formula (4c) L2, X₂, Rᵢ, Rⱼ, Rₖ, R₇, R₈, n″ and m″ are as defined in claim 6;
in formula (5) L and f are as defined in any one of claims 1 to 3 and 7.

12. A composition comprising
a prepolymer as defined in claim 1 or as obtained according to the method of claim 9 and mixtures thereof; and
an additive selected from a plasticizer, a filler, an adhesion promoter, a pigment or dye, a UV-absorber, an antioxidant, a UV-stabilizer, a moisture scavenger, a fungicide, a biocide, a fire-retardant, a rheology modifier, an oxygen barrier and mixtures thereof.

13. The composition of claim 12, further comprising a catalyst, preferably the catalyst is selected from a tertiary amine, an organometallic compound, an acid or an anhydride; more preferably, the catalyst is a metal carboxylate (tin, zinc, iron, lead, copper or titanium carboxylate such as dibutyltin dilaurate (DBTDL), dioctyltin dilaurate, dioctyltin acetylacetonate, copper acetylacetonate, isopropyl triisostearoyl titanate), a carboxylic or sulfonic acid (stearic acid, palmitic acid, oleic acid, 4-dodecylbenzene sulfonic acid, dinonylnaphthalene disulfonic acid, p-toluenesulfonic acid, methanesulfonic acid), a tertiary cyclic amine (1,8-diazabicyclo[5.4.0]undec-7-ene (DBU), 1,5-Diazabicyclo[4.3.0]non-5-ene (DBN), 1,4-diazabicyclo[2.2.2]octane (DABCO)) or an anhydride (methyltetrahydrophthalic anhydride (MHTPA), methylnadic anhydride and methylsuccinic anhydride); even more preferably the catalyst is DBU or DBTDL.

14. A sealant, coating or adhesive obtained by curing the composition as defined in claim preferably at a temperature of −10 to 50° C., in particular −5 to 45° C., more particularly 0 to 40° C., during a time of 1 to 72 h, in particular 2 to 30 h, more particularly 3 to 24 h.

15. A method for waterproofing exterior or interior traffic-bearing horizontal surfaces, for making flashings, or for renovating roofs comprising the step of applying the composition of claim 12.
